(19) United States
(12) Patent Application Publication
(10) Pub. No.: US 2026/0356674 A1
(43) Pub. Date: Nov. 12, 2026

(54) METHODS OF FLASH JOULE HEATING PER- AND POLYFLUORINATED ALKYL SUBSTANCESAND COMPOSITIONS THEREOF

(71) Applicant: William Marsh Rice University, Houston, TX (US)

(72) Inventors: James M. TOUR, Houston, TX (US); Phelecia SCOTLAND, Houston, TX (US); Kevin WYSS, Houston, TX (US); Eddy LUCAS, Houston, TX (US); Wilbur Carter KITTRELL, Houston, TX (US)

(73) Assignee: WILLIAM MARSH RICE UNIVERSITY, Houston, TX (US)

(21) Appl. No.: 19/489,747

(22) PCT Filed: Jun. 10, 2024
(86) PCT No.: PCT/US2024/033209

§ 371 Date: Dec. 3, 2025

Related U.S. Application Data
(60) Provisional application No. 63/507,045, filed on Jun. 8, 2023.

(51) Int. Cl. C01B 32/184; A62D 3/40; A62D 101/22; B09B 3/40; B09B 101/95; C01B 32/16; C01B 32/196; C01B 32/977; C01D 3/02; C01F 7/50; C01F 11/22

(52) U.S. Cl. CPC C01B 32/184; A62D 3/40; B09B 3/40; C01B 32/16; C01B 32/196; C01B 32/977; C01D 3/02; C01F 7/50; C01F 11/22; A62D 2101/22; B09B 2101/95; C01P 2004/16

(57) ABSTRACT

Methods of flash Joule heating of per- and polyfluorinated alkyl substances and compositions thereof, including, particularly, methods of flash Joule heating of per- and polyfluorinated alkyl substances absorbed on adsorbates in the presence of metal salts and compositions thereof.

### CROSS-REFERENCED TO RELATED PATENT APPLICATIONS

The application claims priority to U.S. Patent Appl. Ser. No. 63/507,045, to James M. Tour, et al., entitled “Methods Of Flash Joule Heating Per- And Polyfluorinated Alkyl Substances and Compositions Thereof,” filed Jun. 8, 2023, which patent application is commonly owned by the owner of the present invention and is incorporated herein in its entirety.

### GOVERNMENT INTEREST

This invention was made with government support under Grant No. FA9550-22-1-0526, awarded by the United States Air Force Office of Scientific Research, and Grant No. ERDC W912HZ-21-2-0050, awarded by the United States Engineer Research and Development Center for the United States Army Corp of Engineers. The United States government has certain rights in the invention.

### TECHNICAL FIELD

The present invention relates to methods of flash Joule heating of per- and polyfluorinated alkyl substances and compositions thereof, including, particularly, methods of flash Joule heating of per- and polyfluorinated alkyl substances absorbed on adsorbates in the presence of metal salts and compositions thereof.

### BACKGROUND

Per- and polyfluorinated alkyl substances (PFAS) [Al Amin 2020], also commonly known as “forever chemicals” refer to a group of synthetic compounds that have a combined market size of $28 billion in 2023. [Gluge 2020]. There are over 9,000 types of PFAS, all of them anthropogenic. [Al Amin 2020]. PFAS has been widely used in fire-fighting foams, CO₂-based dry cleaning, non-stick cooking surfaces, food containers, personal care products, and aqueous film-forming foams, making them pervasive in human society. [Hunter Anderson 2019; Xiao 2017]. Although they have many commercial applications, these once indispensable chemicals have recently been linked to several adverse health effects, including cancer, immune suppression, and damage to the reproductive system, liver, kidney, and thyroid. [Stahl 2011; Sunderland 2018]. Due to their chemical inertness, PFAS are not readily decomposed or expelled from the body. [Sonmez Baghirzade 2021]. Now, these persistent, toxic compounds are ubiquitous in drinking water, soil, and the blood of humans and animals [Yeung 2008; Aro 2021], posing an immediate threat to both health [Yeung 2008; Aro 2021] and the environment [Buck 2011; Ellis 2001; Brusseau 2020; Scher 2018].

PFAS-contaminated water is a crucial source of exposure to the general population. [Scher 2018; Xiao 2018]. In response to these concerns, the US Environmental Protection Agency (EPA) recently lowered the maximum contaminant level in drinking water of specific PFAS, including perfluorooctanoic acid (PFOA) and perfluorooctane sulfonic acid (PFOS), each from 70 ng L⁻¹ to 4 ng L⁻¹. [Belkouteb 2020; EPA 2023]. Physiochemical adsorption has become a common strategy to collect PFAS from water streams and comply with these stringent limits. In this strategy, PFAS is adsorbed by granulated activated carbon (GAC) (also alternatively called granular activated carbon) [Gagliano 2021; McCleaf 2017] via hydrophobic interactions, or by anion exchange resins [Dastgheib 2021] through ionic interactions. The chain length and functional groups of the PFAS substantially influence the efficiency of these techniques. [Sonmez Baghirzade 2021].

While they are effective at removing PFAS, sorption methods generate secondary sorbent wastes containing concentrated PFAS. These PFAS-laden sorbent wastes are typically incinerated [Sonmez Baghirzade 2021; Dastgheib 2021; Xiao 2020; Watanabe 2018] at temperatures exceeding 1000 °C. Still, incomplete incineration can release PFAS and produce small, volatile organic fluorinated compounds (VOF) that are often more toxic than the original PFAS. [Watanabe 2018; Watanabe 2016; Feng 2015; Stoiber 2020] Additionally, reports indicate that incineration plants are causing PFAS contamination in surrounding soil, [Martin 2023] well beyond expected background levels. [Brusseau 2020]. Higher concentrations of PFOA have been detected at incinerator sites compared to upwind areas. [Wang 2020]. Commercial-scale incineration of PFAS-contaminated sludges has also yielded PFAS-contaminated secondary ashes. [Loganathan 2007]. Therefore, a thorough comprehension of the fate of fluorine atoms during incineration and any disposal method is imperative. Some studies, both at laboratory and commercial scales, address the fate of fluorine atoms from PFAS during incineration, while others focus solely on the absence of PFAS without comprehensively examining the incineration byproducts. This incomplete understanding of incineration byproducts is among the reasons the Department of Defense (DoD) has proposed banning or restricting the incineration of PFAS. Such legislation aims to prevent the release of PFAS emissions into the atmosphere and mitigate potential health and environmental risks associated with PFAS exposure [NDA 2019].

### SUMMARY OF THE INVENTION

The present invention relates to methods of flash Joule heating of per- and polyfluorinated alkyl substances and compositions thereof, including, particularly, methods of flash Joule heating of per- and polyfluorinated alkyl substances absorbed on adsorbates in the presence of metal salts and compositions thereof.

In general, in one embodiment, the invention features a method that includes selecting a substance selected from the group consisting of per- and polyfluorinated alkyl substances (PFAS). The method further includes subjecting the PFAS to a flash Joule heating process in the presence of a metal salt, metal oxide, or metal(0) to generate a carbon material and a metal fluoride.

Implementations of the invention can include one or more of the following features:

The generated carbon material can be selected from the group consisting of carbon nanotubes, nanodiamonds, nanoshells, nanoonions, nanosheets, amorphous carbon, graphite, silicon carbide, silicon carbide whiskers, silicon carbide tubes, and combinations thereof.

The generated carbon material can be graphene.

The PFAS can include perfluorooctane carboxylate (PFOA) and/or perfluorooctane sulfonate (PFOS).

The PFAS can include exactly one per- and polyfluorinated alkyl substance selected from the group.

The PFAS can include two or more per- and polyfluorinated alkyl substances selected from the group.

The flash Joule process can be performed utilizing the PFAS and an added conductive additive.

The conductive additive can be selected from the group consisting of granulated activated carbon (GAC), activated carbon, graphene, flash graphene, turbostratic graphene, anthracite coal, coconut shell-derived carbon, higher temperature-treated biochar, activated charcoal, calcined petroleum coke, metallurgical coke, coke, shungite, carbon nanotubes, asphaltenes, acetylene black, carbon black, ash, carbon fiber, and mixtures thereof.

The PFAS can be subjected to the flash Joule heating process in the presence of the metal salt.

The PFAS can be subjected to the flash Joule heating process in the presence of the metal oxide.

The PFAS can be subjected to the flash Joule heating process in the presence of the metal(O).

The metal salt, metal oxide, or metal(O) can include a metal selected from calcium, sodium, lithium, potassium and mixtures therefrom.

The PFAS can be subjected to the flash Joule heating process in the presence of Ca(OH)₂, CaO, and/or Ca(0).

The metal salt, metal oxide, or metal(O) can include a metal that is aluminum.

The metal salt, metal oxide, or metal(O) can include a metal is selected from Group 1A, Group 2A, Group 3A, and transition metals, and mixtures thereof.

The graphene can be in a turbostratic arrangement.

The graphene can be in a Bernal arrangement.

The graphene can be in a mixed turbostratic arrangement and Bernal arrangement and all angles in between.

The graphene can be holey wrinkled graphene.

The graphene can be flash graphene.

The flash Joule process can be performed utilizing the PFAS sorbed on granulated activated charcoal (GAC).

The method can further include the step of sorbing the PFAS on the GAC.

The flash Joule process can be performed utilizing the PFAS physically mixed with granulated activated charcoal GAC and the metal fluoride.

The PFAS can be a non-soluble PFAS.

The non-soluble PFAS can be polytetrafluoroethylene (PTFE). (Polytetrafluoroethylene is also commonly known by its brand name “Teflon,” a registered trademark of The Chemours Company).

The flash Joule process can be performed utilizing the PFAS sorbed on a resin.

The resin can be a carbon-silicon-containing resin.

The resin can be an anion exchange resin (AER).

The AER can be a polymeric material that is acid, base, and water insoluble.

The method can further include the step of sorbing the PFAS on the resin.

The metal fluoride can include two or more metal fluorides.

The metal fluoride can be CaF₂ and/or NaF.

The metal fluoride can be AlF₃.

The metal fluoride can be Na₂SiF₆.

At least 90% of fluorine atoms in the PFAS can be converted into the metal fluoride.

At least 94% of fluorine atoms in the PFAS can be converted into the metal fluoride.

At least 96% of fluorine atoms in the PFAS can be converted into the metal fluoride.

At least 99.9% of the fluorine from PFAS can be removed from the substance.

The method has a removal efficiency of at least 99.9% of the fluorine from the PFAS in the substance.

The method can include a zero emissions or near-zero-emissions process.

The method can be performed using a zero emissions or near-zero-emissions device.

The metal fluoride can be inorganic, inert, and non-toxic.

The method can further include removing the metal fluoride from the carbon material by washing with water or an aqueous acid.

The graphene can be washed with an aqueous acid. The aqueous acid can be selected from the group consisting of hydrochloric acid, sulfuric acid, aqueous acetic acid, and combinations thereof.

In general, in another embodiment, the invention features a composite material that includes graphene and a metal fluoride.

Implementations of the invention can include one or more of the following features:

The composite material can be made by any of the above-described methods.

The metal fluoride can include two or more metal fluorides

The metal fluoride can be CaF₂ and/or NaF.

The metal fluoride can be AlF₃.

The metal fluoride can be Na₂SiF₆.

The composite material can further include a composite selected from the group consisting of cement, concrete, asphalt, plastic, wood, paint, coatings, films, inhibitors, rust inhibitors, and lubricants.

### BRIEF DESCRIPTION OF THE DRAWINGS

FIGS. 1A-1B show schematics for synthesis processes of flash graphene, and, respectively, CaF₂ and NaF, in embodiments of the present invention.

FIGS. 2A-2B show schematics for synthesis processes of flash graphene, and, respectively, CaF₂ and NaF, in further embodiments of the present invention.

FIGS. 3A-3D show a scheme, current, and temperature of the FJH for certain embodiments of the present invention. FIG. 3A shows a schematic of the representative setup and process. FIG. 3B shows an image of PFOA-GAC in a weighing boat. FIGS. 3C-3D show (C) the current profile of a typical 150 V (59 mF, 1.00 s) FJH process and (D) the temperature profile of the FJH over the course of the reaction.

FIGS. 4A-4I show quantification and analysis of the mineralization process. FIG. 4A shows inorganic fluoride yield from FJH reaction of PFOA-GAC with 1.2 molar equivalents of sodium per mole of fluoride in PFOA (n=3). FIGS. 4B-4C show the average mass yield distribution of the fluoride recovered from various parts of the reactor for different reaction conditions at 0.50 and 1.00 s flash durations, respectively (n=3). FIG. 4D shows high-resolution F1s spectrum of the PFOA-GAC and fluoride salt/flash graphene product. FIG. 4E shows ¹⁹F NMR spectra of PFOA-GAC and flash graphene product. FIG. 4F shows LC-MS analysis of residual organic fluorine recovered from the rinsed product (n=3). FIG. 4G shows GC-MS analysis of VOF produced during the reaction using varying mole eq ratios of sodium per mole of fluoride in PFOA (n=1). Peaks 1, 2, 3 correspond to the VOF evolved during the reactions and were identified as perfluoropentene, perfluorohexene, and perfluoroheptene, respectively. FIG. 4H shows remaining VOF with increasing molar equivalents of sodium per mole of fluoride (n=1 experiment per reaction condition). FIG. 4I shows graphene yield for the FJH samples, showing representative graphene samples from the experimental process (n=1 sample per reaction condition). All error bars represent standard deviation.

FIGS. 5A-5F show analysis of PFOA-GAC mixed with Ca(OH)₂ as the mineralizing reagent. FIGS. 5A-5B show ion chromatography analysis of the samples, post-FJH. FIG. 5C shows thermodynamics analysis using the HSC chemistry package. FIG. 5D shows the average Raman spectra of the 110 V and 130 V flash at 60 mF. FIG. 5E shows bulk crystal structure analysis by XRD of the Ca(OH)₂, PFOA-GAC mixed with Ca(OH)₂, and the product after FJH at 130 V. FIG. 5F shows a TEM image containing an FFT inset of the highlighted area.

FIGS. 6A-6F show analysis of PFOA-Resin mixed with NaOH as the mineralizing reagent. FIG. 6A is XPS of the original PFOA-Resin. FIG. 6B shows Fourier-transform infrared spectroscopy (FTIR) of the anion exchange resin with adsorbed PFOA. FIG. 6C shows thermal gravimetric analysis-differential scanning calorimetry (TGA-DSC) FIG. 6D shows reaction vessel after FJH. FIG. 6E shows XRD analysis of the post reaction powder. FIG. 6F shows ion chromatography results of the reactions.

FIGS. 7A-7D show simulations of PFOA reacting with NaOH at high temperatures.

FIG. 7A is a schematic of molecular dynamics simulation of optimized PFOA with the highest loading of NaOH (F₁₀₅Na₉₆), annealed between 1500 and 2500 K. FIG. 7B shows a number of unbroken C—F bonds calculated based on FIG. 7A. FIGS. 7C-7D show thermodynamic analysis using the HSC chemistry package.

FIG. 8A-8D show simulations of PFOA reacting with NaOH at high temperatures.

FIG. 9 shows a first reaction pathway of a DFT simulations between NaOH and PFOA.

FIG. 10 shows a second reaction pathway of a DFT simulations between NaOH and PFOA.

FIG. 11 shows a believed reaction pathway for the degradation of PFOA in the presence of NaOH via FJH into inorganic fluorine salts.

FIG. 12A-12E show a comparative life cycle assessment (LCA) and (techno-economic assessment (TEA) of FJH as compared to other PFAS-GAC remediation methods. FIG. 12A is a diagram showing the methods considered for PFAS-GAC remediation, with associated inputs and the fate of the GAC and PFAS. FIG. 12B shows the cumulative energy demand of each GAC remediation method evaluated. FIG. 12C shows the global warming potential of each GAC remediation method evaluated. FIG. 12D shows cumulative water use of each GAC remediation method evaluated. FIG. 12E shows the projected cost of each process incorporates expenses related to both materials and the production process, with the sale of the graphene in the FJH process at $3,000 per ton of graphene.

FIG. 13 shows schematics of a zero emission PFAS FJH reactor.

### DETAILED DESCRIPTION

The present invention relates to methods of flash Joule heating of per- and polyfluorinated alkyl substances and compositions thereof, including, particularly, methods of flash Joule heating of per- and polyfluorinated alkyl substances absorbed on adsorbates in the presence of metal salts and compositions thereof.

Efficient and straightforward processes have been discovered for disposing of PFAS-laden GAC (PFOA-GAC) using flash Joule heating (FJH) to mineralize the sorbed PFAS, resulting in a definitive endpoint for the fluorine atoms. FJH is a process by which the current through a medium rapidly heats the medium to high temperatures to induce a chemical reaction. [See, e.g., Tour 2021 PCT Applications; Tour PCT '987 Application]. This technique has found broad applications in waste management and recycling. For instance, it has been used in the upcycling of waste materials [Algozeeb 2020, Cheng 2024], regeneration of graphite in spent lithium-ion batteries [Dong 2022; Chen 2023] the remediation of heavy metals and polycyclic aromatic hydrocarbons in soil, [Deng 2023] and recently the remediation of PFAS in soil even up to kilogram scales [Cheng 2023]. The mechanism of flash Joule heating uses the target feedstock as the heating medium, making it a fast and efficient indirect heating technique.

New processes have been discovered in which significant amounts of PFOA-GAC, (such as >96% of PFOA-GAC) can be degraded during FJH, forming inorganic salts with <0.01% of the initial PFAS remaining. This can be accomplished by the <1 s FJH of the PFAS-GAC in the presence of NaOH or Ca(OH)₂, achieving temperatures >3000 °C and mineralizing the organic fluorine to NaF or CaF₂, respectively.

Molecular dynamics investigations reveal that sodium and calcium may function as catalytic reagents that promote the breakage of the C—F bond. Furthermore, the results demonstrate that trace amounts of degraded VOF short-chain PFAS are formed in the FJH process in the presence of mineralizing reagents. The GAC is converted into crystalline flash graphene, a valuable co-product that can be sold to offset the cost of the decontamination process (or additionally/alternatively, other forms of carbon materials, such as carbon nanotubes, nanodiamonds, nanoshells, nanoonions, nanosheets, amorphous carbon, graphite, silicon carbide, silicon carbide whiskers, and silicon carbide tubes). A life cycle assessment (LCA) shows that this process offers low energy and water consumption and produces minimal greenhouse gas while upcycling toxic and concentrated secondary waste streams into valuable graphene (or other carbon materials) and inert inorganic salts. These results provide a foundational technique for the clean and efficient upcycling of spent sorbent materials, enabling the more effective treatment of PFAS-contaminated water.

In embodiments, one can flash Joule heat (FJH) a mixture of PFAS on adsorbates (granulated activated carbon-GAC, anionic, cationic, and nonionic resins, PFAS-specific resins could also be used, and in those resin cases a conductive carbon additive like GAC or carbon black or metallurgical coke—metcoke—or biochar might be used as conductive additives) with various metal cationbased quenching agents to produce flash graphene, carbon nanotubes, nanodiamonds, nanoshells, nanoonions, nanosheets, amorphous carbon, graphite, silicon carbide, silicon carbide whiskers, and/or silicon carbide tubes plus metal fluoride salts.

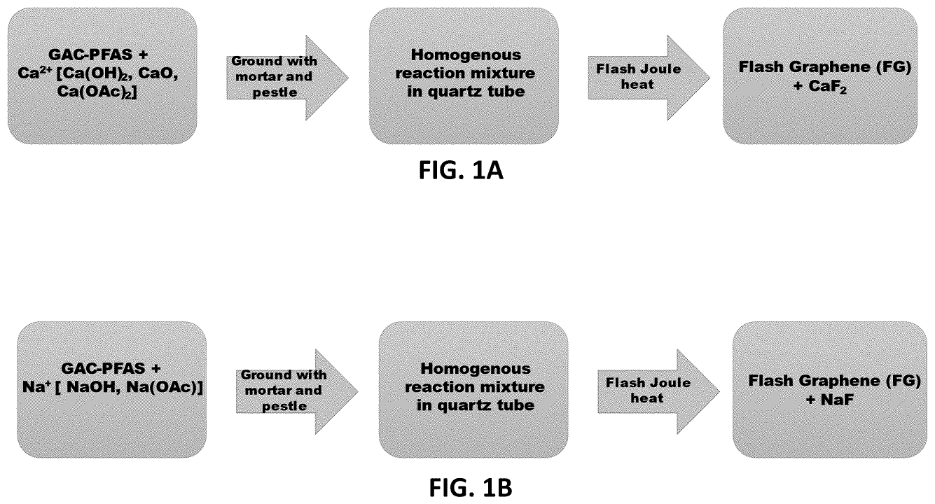

General workflows for the process and composition of matter for embodiments of the present invention are shown in FIGS. 1A-1B. While these general workflows show the synthesis of flash graphene (with CaF₂ or NaF) this is representative of the synthesis for other forms of carbon materials, such as carbon nanotubes, nanodiamonds, nanoshells, nanoonions, nanosheets, amorphous carbon, graphite, silicon carbide, silicon carbide whiskers, and silicon carbide tubes (based upon the control of the parameters and declarations). Parameters and declarations for certain embodiments utilized for synthesis of flash graphene (which is turbostratic graphene), CaF₂ and NaF are directly below.
(1) PFAS-laden substrates (so far demonstrated with GAC/PFOA/PFOS), calcium based quenching agents (Ca(OH)₂, which is calcium hydroxide, CaO which is calcium oxide, Ca(OAc)₂ which is calcium acetate and CaCO₃ which is calcium carbonate) can be converted into flash graphene (FG) plus inert, non-toxic CaF₂.
(2) PFAS-laden substrate (so far demonstrated by GAC/PFOA/PFOS), sodium based quenching agents (NaOH, which is sodium hydroxide, Na(OAc) which is sodium acetate), and Na₂CO₃ which is sodium carbonate) can be converted into FG and NaF.
(3) The PFAS-laden substrate can be mixed with stoichiometric equivalent (0.5 calcium ions for every fluoride atom or 1.0 sodium atom for every fluoride) or slight excess of the salt (0.6 calcium ions for every fluoride atom or 1.1 sodium atom for every fluoride atom) and the solids are ground together using a mortar and pestle to form a homogenous mixture. On a larger scale, this can be accomplished by a mechanical mixer or ball miller. For highly concentrated PFAS-waste streams or more recalcitrant types of PFAS, higher loading of mineralizing agents can be utilized (1.0 calcium ions for every fluoride atom or 1.5 sodium atom for every fluoride atom).
(4) The reaction product can be processed (see (5), below) and analyzed for inorganic fluoride using Ion Chromatography (IC). IC detects fluoride ions dissolved in a solvent (usually water). The byproduct CaF₂ is typically poorly soluble in water (0.016 g/L at 20 °C). Pure CaF₂, when dissolved in water, showed a linear trend up to ~5 ppm via IC. Thus, these limitations should be taken into consideration for sample preparation and post-FJH analysis. Diluting the GAC/PFAS samples with a carbon additive such as neat GAC or carbon black reduces the PFAS concentration per loading, resulting in the concentration of CaF₂ being within the soluble, linear range for IC analysis. Dilution of the as-received GAC sample with neat GAC also lowers the concentration of PFAS to concentrations more realistic to be observed from water treatment plants, although this FJH process described here can be used on a wide range of concentrations of PFAS on support, from parts per billion to tens of percent, such as 1 ppb PFAS on GAC to 50 wt % PFAS on GAC.

Another benefit of sample dilution with added carbon is that using the sealed system, the quartz tubes are prone to being shattered due to the pressure difference inside and outside of the tube. Reducing the amount of inorganic fluoride formed lessens the increase of pressure within the tube thus keeping the tube intact. Overall, sample dilution allows for more accurate quantification of the mineralized fluoride ions and will not be required for optimized process scale-up of realistic carbon adsorbent feedstocks. Sample dilution assists the lab scale work and the lab scale analytical determinations. Upon industrial use, quartz tubes will not be used. Other most robust materials, like high-temperature concrete housings, might be used.

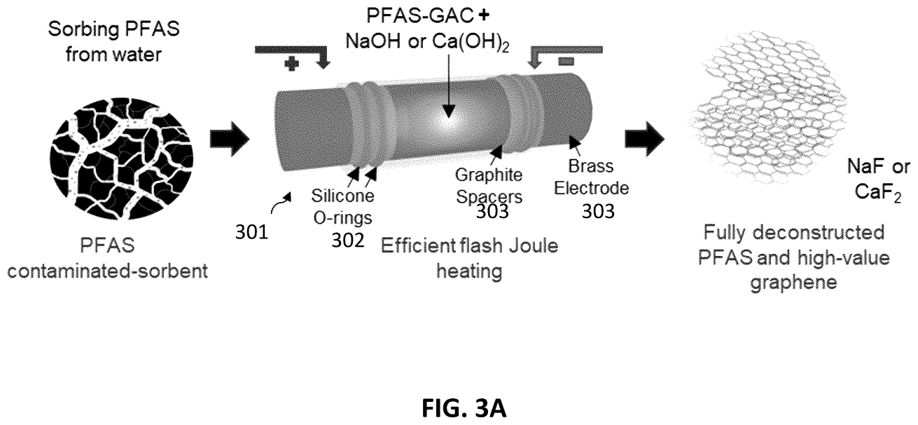

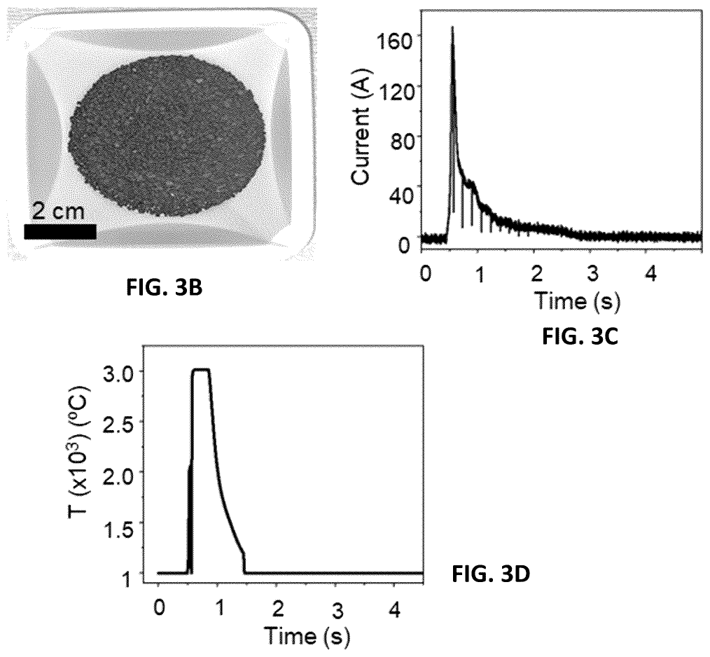

(5) 100 mg of the sample mixture can then be flash Joule heated in a quartz tube. The quartz tube has an inner diameter of 8 mm and is ~9 cm long. The sample is fitted between two snug graphite electrodes which are both about 3 mm long. 0.5 g of copper wool is placed on each side of the graphite electrodes to enhance the electrical contact between the sample and external brass electrodes. The quartz tube containing the sample, electrodes, and copper wool, is placed between two brass electrodes as shown in FIG. 3A. In this embodiment, the diameter of the brass electrodes is about 8 mm, and each contains two, 2 mm grooves. The grooves are distributed vertically, 5 mm and 10.5 mm from the tip. 008 silicon O-rings were fitted into the grooves on both ends. This allows the sample and reaction area to be well-sealed to minimize the volatilization of any reaction species as off-gas. This set up maximizes the formation of inorganic fluoride species, by maximizing feedstock retention over the duration of the flash.

(6) Initial reactant conductivities for best performance in these embodiments were 1-2.5 Ω/cm of compressed sample loaded in an 8 mm internal diameter quartz tube.

(7) In these embodiments, pulse delivery ranges from 500-5000 milliseconds while the voltage and capacitance range from 110-150 V and 60-96 mF, respectively.

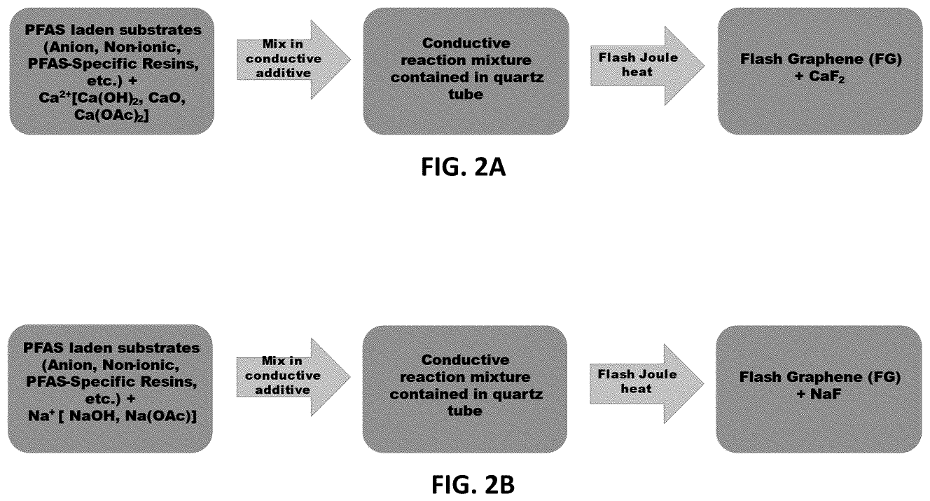

General workflows for the process and composition of matter for further embodiments of the present invention are shown in FIGS. 2A-2B. PFAS adsorbed to other substrates, such as anion exchange resins, can also be flash Joule heated. Ion exchange resins are typically made from organic polymer substrates. The resulting resin product is often nonconducting. Thus, it must be mixed with a conductive additive, such as carbon black, metcoke, or biochar, before flash Joule heating. Generally, any carbon material (from the additive and or polymer) will convert to flash graphene or other material based on conditions, such as carbon nanotubes with the addition of an iron catalyst. The PFAS molecules will decompose to form radicals and will react with the quenching agent to form mineralized fluoride in the form of CaF₂ and NaF. The non-carbon material will volatilize and or decompose due to the reaction temperatures.

Direct Conversion of PFOA-GAC into Inorganic Fluoride Salts by FJH

PFOA was used as a representative PFAS type. A mixture of PFOA-GAC and NaOH was prepared as follows. 0.40 g of PFOA-GAC (39.48 mg of PFOA g⁻¹) was mixed with 69 mg of NaOH (1.2 mole eq of sodium per mole of F in PFOA). The sample was ground with a mortar and pestle to ensure that the NaOH was in close contact with the PFOA. Then, 0.20 g of the mixture was mixed with 1.00 g of neat GAC and ground using a mortar and pestle, providing a calculated starting concentration of 9.65 mg PFOA g⁻¹ sorbent. To verify this, combustion ion chromatography (CIC), a technique used to determine the total fluorine content in solid or liquid samples, was used. The average concentration of the starting feedstock was (0.951±0.022) wt % (n=3 and R²=0.9980). The calculated value of 0.965 wt % is within this range so the calculated value was used to determine the removal and mineralization efficiency.

0.10 g of stock material was subjected to FJH using a double O-ring sealed system 301 (shown in FIG. 3A with silicon O-rings 302, graphene spacers 303, and brass electrode 304). The quartz tubes are prone to being shattered due to the pressure difference inside and outside of the tube. Thus, a spring wrapped outside the tube reduced the likelihood of tube shatter. The typical resistance across the sample in the quartz tube was 1.2 to 2.0Ω. The current discharge was an unmodulated DC discharge with a capacitance of ~59 mF, with the initial voltage and pulse time ranging from 110 to 150 V and 0.50 to 1.00 s. To ensure thorough washing and extraction, the samples were rinsed with excess HPLC grade water (20 to 50 mL) after FJH and subjected to agitation by shaking for 24 h. The samples are then sonicated for 10-15 min to release any fluorine byproducts that may remain on the flash graphene (FG), or on the reactor components.

The packed sample exhibited a typical resistance of 1.2 to 2.0Ω, a suitable resistance for direct-current FJH. [Luong 2020]. FIG. 3B displays an image of the PFOA-GAC sorbent, which displays a homogeneous morphology indicative of complete mixing of PFOA and mineralizing agents. Conventional FJH utilizes direct current (DC) capacitor discharges in which the energy of the discharge was determined by the voltage of the flash and the capacitance of the capacitors used. Electronic switches can interrupt these discharges so that the discharge duration can be controlled on a timescale of milliseconds to a few seconds. This enabled the energy and the duration of FJH to be highly tunable, facilitating reaction optimization. In this embodiment, the reactants were subjected to FJH at 110 V to 150 V for durations of either 0.50 s or 1.00 s. These reactions resulted in a high current (FIG. 3C) and a rapid temperature increase up to >3000 °C (FIG. 3D), which decays over the course of 2 to 3 s.

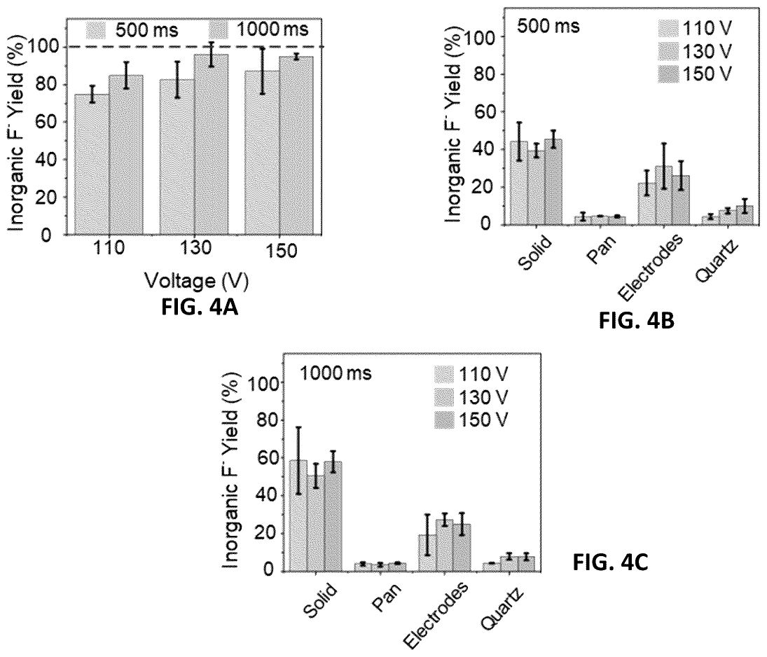

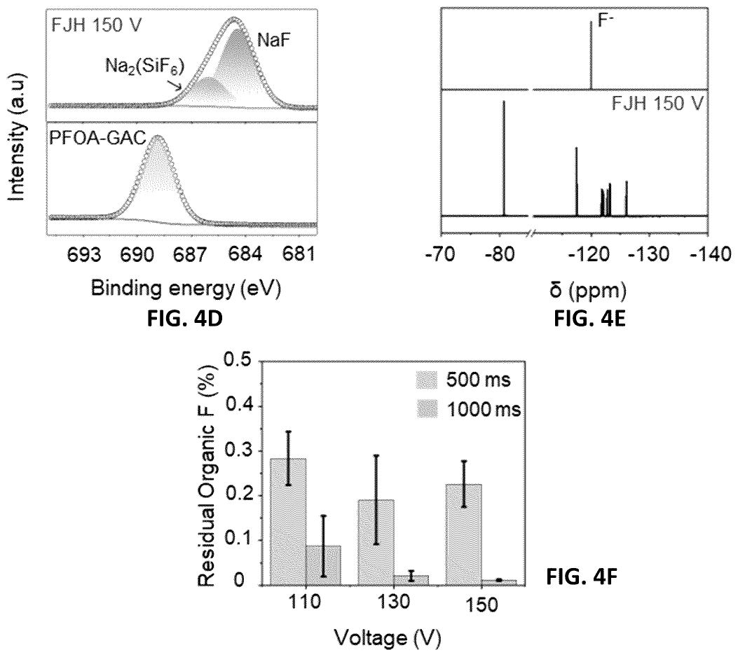

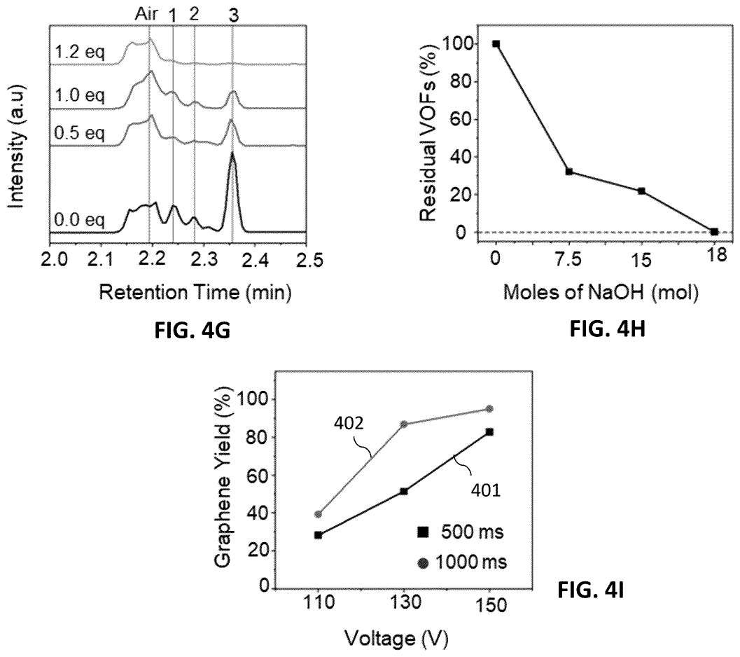

While Ca(OH)₂ can be optimal for industrial use since the more common natural mineralized form of fluoride is the calcium salt, NaOH was also used as the mineralizing reagent due to the higher solubility of NaF with water. This choice facilitates easier and more accurate quantification of the mineralization efficiency. The high temperatures achieved by the rapid resistive heating resulted in the reaction of PFOA with NaOH, forming NaF through the strong bond association of the fluoride anion to the sodium cation. The resulting products were analyzed using ion chromatography (IC) to quantify the degree of mineralization. FIG. 4A shows that an average of (0.927±0.063) wt % or ~96% of organic F in PFOA was converted to inorganic fluoride at 130 V for 1.00 s when 1.2 mole equivalents (eq) of NaOH were used per mole of fluoride in the starting stock. When the control PFOA-GAC (without sodium or calcium) was FJH at 130 V for 1.00 s, only (0.370±0.138) wt % or ~38% of the total fluorine was detected in the form of inorganic fluoride by IC analysis. See TABLE I.

TABLE I
FJH Reaction Parameters

| Sample ID | GAC | GAC/PFOA | GAC/PFOA/NaOH |
|---|---|---|---|
| Mass_{I} (g) | ~0.1 | ~0.1 | ~0.1 |
| Resistance (ohms) | 1.3 | 1.2 | 1.21 |
| V_{I} (V) | 130 | 130 | 130 |
| V_{F} (V) | 90 | 92 | 75.5 |
| I_{Max} (amps) | 172.3 | 115.78 | 199.04 |
| Time (s) | 1.00 | 1.00 | 1.00 |
| ATM (in. Hg) | −29 | −29 | −29 |
| Capacitance (mF) | 60 | 60 | 60 |
| Mass_{F} (g) | 0.0921 | 0.0882 | 0.0836 |
| Graphene Yield (%) | 73 | 52 | 87 |
| Total Energy Input (J) | 264.00 | 253.08 | 335.99 |
| Total energy (kJ g⁻¹) | 2.64 | 2.52 | 3.35 |
| Mineralizing Agent | None | None | ×1.2 molar excess |
| | | | NaOH |
| Temperature (°C) | ~2700 | ~2700 | >3000 |

Control experiments were conducted: FJH 0.1 g of GAC (F400) without PFOA and FJH 0.1 g of GAC PFOA without NaOH or other mineralization reagents. 0.1 g of sample was FJH using the following parameters: 130 V, 1.00 s, 60 mF, and −29 in Hg atmosphere. The experiments were conducted in triplicate (n = 3). For efficient mineralization and graphene formation, it is essential to maintain not only an optimal temperature but also an appropriate current profile.

This underscores the role of NaOH in enhancing the conversion efficiency of organic fluorine to inorganic fluoride during Fry treatment, as demonstrated by the substantially higher mineralization rate observed in the presence of sodium ions. This provides a definitive endpoint for the fluorine atoms.

The sample mass, capacitance, and voltage discharged through the sample directly determines the thermal energy generated and the highest temperature achieved. TABLE II shows the results of the Welch two-sample t-test analysis, to gauge the significance of using different voltage and reaction times.

TABLE II
Welch Two-Sample t-Test Analysis

| | | | | | | |
|---|---|---|---|---|---|---|
| Column 2 | 130 V, | 130 V, | 150 V, | 110 V, | 150 V, | 150 V, |
| | 1.00 s | 1.00 s | 1.00 s | 1.00 s | 1.00 s | 1.00 s |
| vs. | vs. | vs. | vs. | vs. | vs. | vs. |
| Column 1 | 130 V, | 110 V, | 130 V, | 130 V, | 110 V, | 130 V, |
| | 0.50 s | 1.00 s | 0.50 s | 0.50 s | 1.00 s | 1.00 s |

Unpaired t-test with Welch's correction

| | | | | | | |
|---|---|---|---|---|---|---|
| P value | 0.004 | 0.035 | 0.0018 | 0.1714 | 0.0258 | 0.6954 |
| P value | ** | * | ** | ns | * | ns |
| summary | | | | | | |
| Significantly | Yes | Yes | Yes | No | Yes | No |
| different | | | | | | |
| (P < 0.05)? | | | | | | |
| One- or two- | Two- | Two- | Two- | Two- | Two- | Two- |
| tailed | tailed | tailed | tailed | tailed | tailed | tailed |
| P value? | | | | | | |
| Welch- | t = | t = | t = | t = | t = | t = |
| corrected | 4.109, | 2.542, | 5.711, | 1.506, | 3.121, | 0.4157, |
| t, df | df = | df= | df = | df = | df = | df = |
| | 7.404 | 7.876 | 5.375 | 7.791 | 5.061 | 4.854 |

How large is the difference?

| | | | | | | |
|---|---|---|---|---|---|---|
| Mean of | 80.25 | 85.69 | 80.25 | 80.25 | 85.69 | 96.28 |
| column 1 | | | | | | |
| Mean of | 96.28 | 96.28 | 94.91 | 85.69 | 94.91 | 94.91 |
| column 2 | | | | | | |
| Difference | 16.03 ± | 10.59 ± | 14.66 ± | 5.440 ± | 9.220 ± | −1.373 ± |
| between | 3.902 | 4.167 | 2.567 | 3.611 | 2.954 | 3.303 |
| means | | | | | | |
| (C2-C1) ± | | | | | | |
| SEM | | | | | | |
| 95% | 6.909 | 0.9584 | 8.198 | −2.927 | 1.654 | −9.940 |
| confidence | to | to | to | to | to | to |
| interval | 25.16 | 20.23 | 21.12 | 13.81 | 16.79 | 7.194 |
| R squared | 0.6952 | 0.4508 | 0.8585 | 0.2256 | 0.6581 | 0.03437 |
| (eta | | | | | | |
| squared) | | | | | | |
| Sample | 5 | 5 | 5 | 5 | 5 | 5 |
| size, | | | | | | |
| Column 1 | | | | | | |
| Sample | 5 | 5 | 3 | 5 | 3 | 3 |
| size, | | | | | | |
| Column 2 | | | | | | |

Two additional experiments were conducted for the samples where n = 5.
* Represents significance: ns represents not significant.

The comparison of inorganic fluoride yield under various conditions reveals a significant trend: higher voltages and longer reaction times generally enhance recovery. However, there is a threshold where further voltage increases do not significantly improve yield, exemplified by the non-significant difference between 130 V and 150 V for 1.00 s. Operating at 150 V poses practical challenges like tube cracking, sample loss, and side reactions.

Comparing 110 V for 1.00 s to 130 V for 0.50 s showed comparable yields, indicating that extending reaction time at lower voltage compensates for shorter, higher-voltage reactions. This underscores the importance of balancing voltage and duration in flash reactions, where adjusting duration can be used to optimize yield without raising voltage, providing flexibility and kinetic control over fluoride mineralization.

The localization of NaF within the reaction vessel was also evaluated. FIGS. 4B-4C show the recovery location for the resultant NaF within the reactor, as quantified by ion chromatography. The inorganic salts were found largely mixed with the solid powder flash graphene product, deposited onto the graphite electrodes, and small amounts adhered to the inner walls of the quartz tube.

High-resolution X-ray photoelectron spectroscopy (XPS) in FIG. 4D compared the PFOA-GAC with the products from the FJH reaction at 150 V and 1.00 s. The F is peak of PFOA-GAC appears at a higher binding energy (688.9 eV) compared to that of the flashed product (684.5 eV). The corresponding F is peak of the product can be deconvoluted to a NaF peak at 684.5 eV and a second peak at 686.0 eV, indicating sodium fluorosilicate Na₂(SiF₆). The Na₂(SiF₆) is present in small amounts due to the reaction with the quartz tube. Na₂(SiF₆) is water soluble, and the resultant anion can further dissociate into water to give fluoride ions. Thus, the fluoride formed as Na₂(SiF₆) can be detected using IC. Fluorine-19 nuclear magnetic resonance spectroscopy (¹⁹F NMR) also shows the disappearance of the PFOA peaks and the formation of a distinct inorganic fluoride peak (FIG. 4E). [Ellis 2003].

To determine if any PFOA remained after the FJH reactions, the flash graphene and reactor components were washed (as discussed above), and the filtrates were analyzed using LC-MS (FIG. 4F). On average, <0.01% of PFOA remains when FJH reaction conditions are at 150 V and 1.00 s.

However, the following fluorine mass balance was performed using experiments conducted at 130 V and 1.00 s, since these parameters provided the highest mineralization ratio. LCMS determined that (0.000151±1.999×10⁻⁵) wt % of fluorine from PFOA remained after the reaction. This accounts for 0.0156% of the starting fluorine. Thus, the removal efficiency of this process is ~99.98% for PFOA. The removal efficiency was calculated using Equation 1, where Cₒ and C_{F} are the initial and final concentrations, respectively.

$$\% Removal = \frac{{C}_{o} - {C}_{F}}{{C}_{o}} \times 100 \qquad ( 1 )$$

Further, LCMS determined that (0.001173±1.62441×10⁻⁴) wt % of fluorine from PFOA remained in the control samples when no sodium was used. This accounts for 0.122% of the starting fluorine. Hence, the removal efficiency was lowered to ~99.88% for PFOA.

TABLE III
LCMS Quantification Of C4-C8 Of GAC FJH At 130 V (n = 3)

| PFCA degradation | Average Conc. | | |
|---|---|---|---|
| species | (wt %) | Std | R² |
| C4 | 0 | 0 | 0.9967 |
| C5 | 0 | 0 | 0.9998 |
| C6 | 0 | 0 | 0.9997 |
| C7 | 0 | 0 | 0.9994 |
| C8 | 8.6E⁻¹⁰ | 6.2E⁻¹⁰ | 0.9998 |

Trace amounts of PFOA were detected in the neat GAC sample when FJH was at 130V.

Short-chain perfluorocarboxylic acid (PFCA) degradation products (C4 to C7) were detected using LC-MS. The total concentration of fluorine from the C4-C7 degradation products was (0.0001031±1.75822×10⁻⁵) wt %, representing 0.0107% of the initial fluorine content. In the absence of sodium, the average remaining organic fluorine (C4 to C7) was (0.00029973±1.75822×10⁻⁵) wt %, constituting 0.0311% of the initial fluorine. These findings indicated that the presence of sodium reduces the occurrence of short-chain PFCAs. Further, residual short-chain PFCAs could potentially be mineralized more effectively under higher voltages, prolonged reaction times, or increased concentrations of initial sodium ions.

Gas chromatography-mass spectrometry (GC-MS) was used to ascertain whether VOF were being generated. The off gas from the reaction was captured and tested. GC-MS revealed a discernible trend: an increase in the stoichiometric ratio of NaOH corresponded to a decrease in the presence of evolved VOF (FIG. 4G). In the chromatogram, the peak between 2.15 to 2.22 min corresponds to air. The peaks labeled 1, 2, and 3 correspond to gases released during the reactions and were identified as perfluoropentene, perfluorohexene, and perfluoroheptene, respectively. The addition of 1.2 mol equivalents of NaOH per fluorine atom in a PFOA-GAC mixture resulted in a 99.81% reduction of VOF at 130 V for 1.00 s, as illustrated in FIG. 4H and TABLE IV. (The area under the curves of the GC chromatogram shown in FIG. 4G can be determined by integration. The amount of VOF evolved is significantly reduced with the addition of NaOH. When 1.2 molar equivalents of sodium per mole of F was added to the PFOA-GAC, the reduction of evolved VOF was ~99.81%. The percentages of remaining VOF shown in FIG. 4H were calculated based on these values. In a completely sealed system, it is likely that little to no detectable VOF is formed during typical reaction conditions.)

TABLE IV
Gas Chromatography-Mass
Spectrometry (GC-MS)

| Molar eq of Na⁺ per mole | Integrated | Reduction in |
|---|---|---|
| of F in PFOA | Area | evolved VOF (%) |
| 0 | 4.87 × 10⁹ | 0.0 |
| 0.50 | 1.56 × 10⁹ | 67.97 |
| 1.00 | 1.06 × 10⁹ | 78.23 |
| 1.20 | 9.02 × 10⁶ | 99.81 |

This result shows that excess mineralizing reagents can mitigate the formation of VOF in the degradation of PFAS-GAC.

During FJH, GAC was transformed into highly crystalline turbostratic flash graphene (GAC-FG). FIG. 4I (with plots 401-402 for 500 ms and 1000 ms, respectively) illustrates the graphene yield for a representative set of samples obtained during the process, affording >95% yield at 150 V for a 1.00 s flash.

Accordingly, recovery of ~96.03% was achieved of the initial fluorine content under the reaction conditions of 130 V for 1.00 s.

The missing fluorine from the total mass balance was investigated. The reaction tube post-FJH shows significant blackening, especially near the middle section, furthest from the heat-sinking electrodes, where the reaction becomes hottest. After washing the tube and drying, Raman spectroscopy and XPS revealed peaks indicative of insoluble sodium fluorosilicate, possibly NaSiF₃O. The atomic percentage after rinsing ranges from 2.68% to 3.63% on the surface of the tube. TABLE V.

TABLE V
High-resolution XPS Analysis Of The Quartz Tube After
Rinsing (NaOH Mineralizing Reagent)

| Sample | C (at %) | F (at %) | O (at %) | Na (at %) | Si (at %) |
|---|---|---|---|---|---|
| Sample 1 | 53.99 | 3.63 | 28.28 | 10.78 | 3.33 |
| Sample 2 | 57.61 | 2.68 | 26.37 | 9.96 | 3.39 |

However, since XPS is a surface analytical method, it is difficult to quantitate this additional deposit of fluorine into a complete mass balance, but it is suggestive that the residual trace fluoride is not volatilized through the double-O-ring seals but reactive with the FJH vessel. [Xiao 2023]. Although the PFOA removal efficiency for GAC/PFOA (without sodium), FJH at 130 V and 1.00 s was 99.88%, only 38.49% of total fluorine could be accounted for using our current analytical techniques. A stark difference when compared to the samples FJH with excess sodium.

### Other PFAS-Sorbents And Mineralizing Reagents

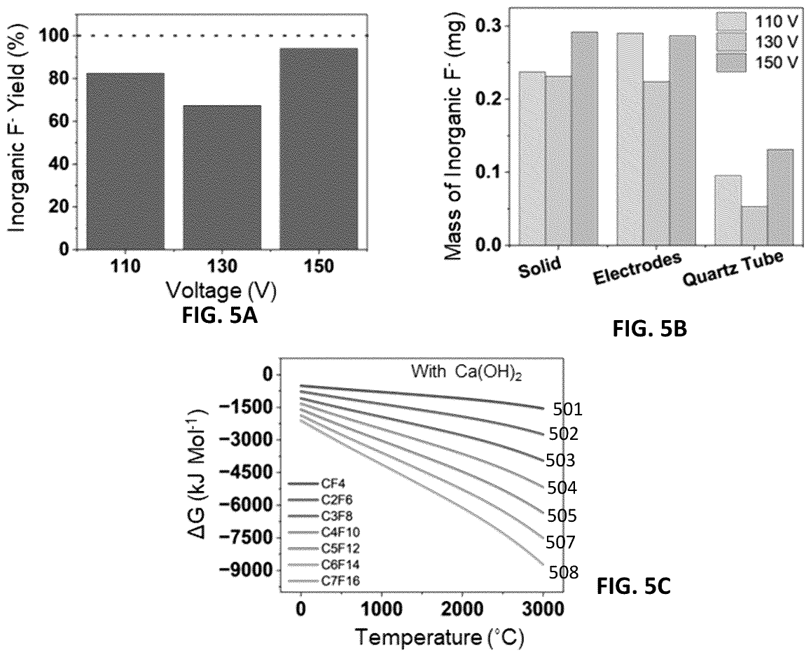

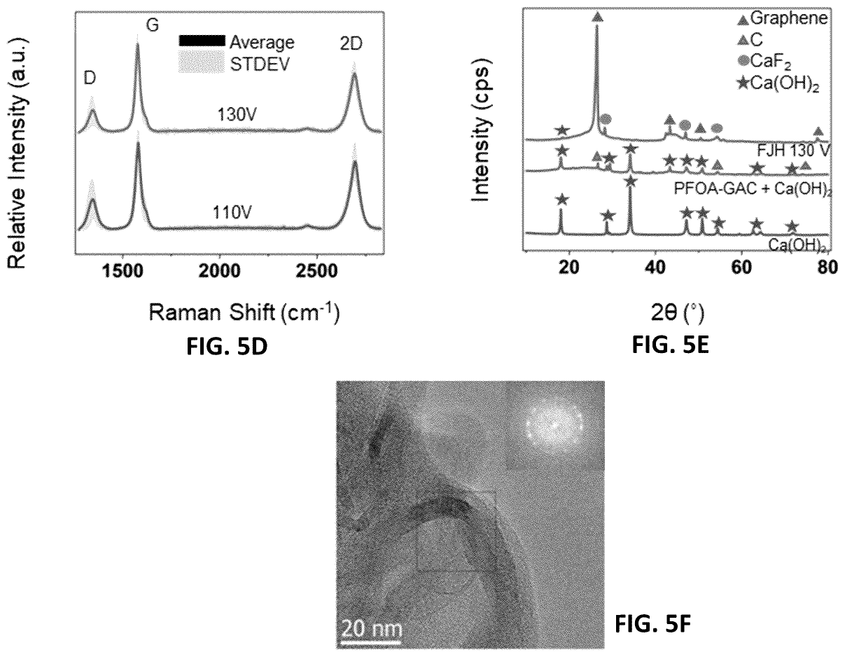

Other ionic salts can be used to promote the mineralization of fluorine. FIGS. 5A-5F show the efficacy of Ca(OH)₂ as a mineralizing reagent (1 molar eq calcium per mole of F using Ca(OH)₂ and FJH at 110-150 V for 0.50 s). Employing a methodology similar to discussed above for reactions using NaOH, PFOA-GAC was mixed with excess Ca(OH)₂ and subjected to FJH. (0.40 g of PFOA-GAC (37.8 mg PFOA g⁻¹) was mixed with 61 mg of Ca(OH)₂ (1.2 mole eq of sodium per mole of F in PFOA) and ground using a mortar and pestle. 0.20 g of this mixture was mixed with 1.30 g of neat GAC. 0.10 g of this feedstock containing ~7.8 mg PFOA g⁻¹ of sorbent was FJH at 110 to 150 V, 0.50 s, and 59 mF. 0.1 M H₂SO₄ was used to rinse the post-reaction samples to leach the CaF₂.)

The reaction at 150 V for 0.50 s resulted in 94% of the fluoride being converted into CaF₂. Due to the low solubility of CaF₂, the actual mineralization ratio may be slightly underreported. FIGS. 5A-5B show ion chromatography analysis of the samples, post-FJH. 94% of elemental F present in the starting material is recovered as mineralized fluoride when FJH at 150 V (n=1). FIG. 5C shows thermodynamics analysis using the HSC chemistry package shows that the mineralizing agent reacts readily with all fluorocarbons. (FIG. 5C shows plots 501-507 for CF₄, C₂F₆, C₃F₈, C₄F₁₀, C₅F₁₂, C₆F₁₄, C₇F₁₆, respectively). This suggests that the addition of Ca(OH)₂ drives the mineralization process. FIG. 5D shows the average Raman spectra of the 110 V and 130 V flash at 60 mF. The spectra were collected from 100 sampling points of the powdered product. The average D/G and 2D/G intensity ratios of the 110 V flash are 0.34 and 0.68, respectively. The graphene yield is 96%. The average D/G and 2D/G intensity ratios of the 130 V flashes are 0.25 and 0.72, respectively. The graphene yield is 98%. High-quality FG was produced. FIG. 5E shows bulk crystal structure analysis by XRD of the Ca(OH)₂, PFOA-GAC mixed with Ca(OH)₂, and the product after FJH at 130 V. The circles highlight the CaF₂ phase. FIG. 5F shows a TEM image containing an FFT inset of the highlighted area shows turbostratic stacking of the domains and strong graphitic character with minimal amorphous character.

The inner surface of the reaction tube was analyzed using XPS after rinsing with 0.1 M of H₂SO₄ and drying. Up to 1.62% of surface fluoride can remain on the blackened area of the post-reaction tube after washing. TABLE VI.

TABLE VI
High-resolution XPS Analysis Of The Quartz Tube After
Rinsing (Ca(OH)₂ Mineralizing Reagent)

| Sample | C (at %) | F (at %) | O (at %) | Ca (at %) | Si (at %) |
|---|---|---|---|---|---|
| Sample 3 | 21.3 | 1.62 | 55.99 | 4.85 | 16.23 |
| Sample 4 | 27.86 | 0.72 | 47.79 | 4.51 | 9.12 |

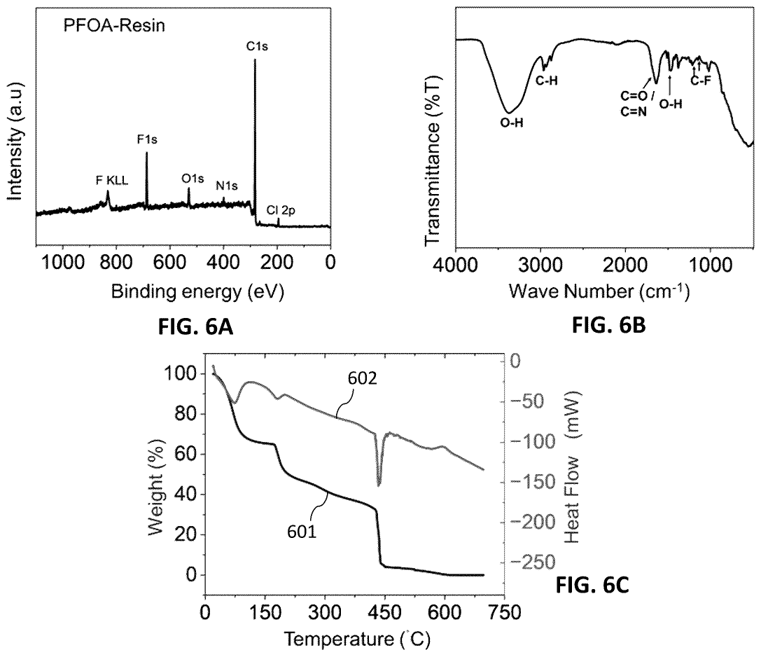

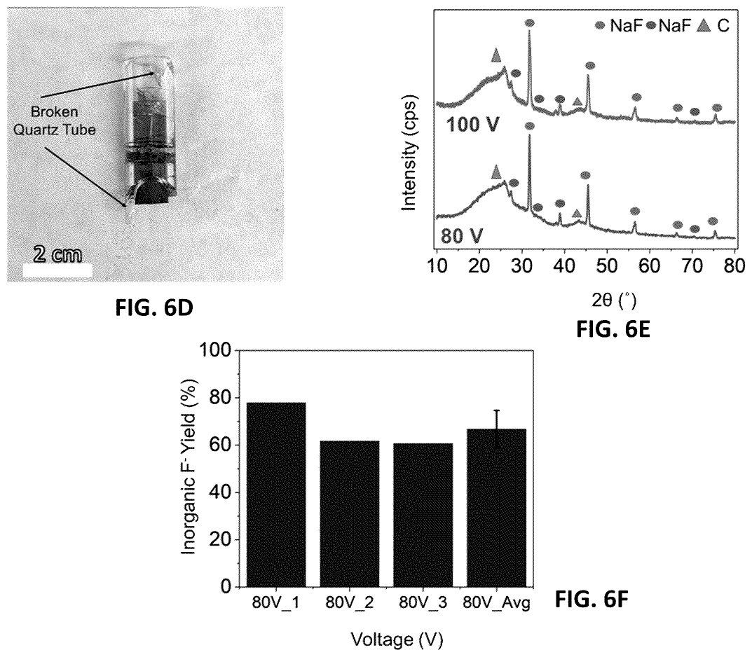

Alternative sorbents, such as anion exchange resins, offer an effective means of PFAS removal from water. One such example is Purofine PFA694 resin, consisting of polystyrene beads with an amine-functional group. FJH of this PFAS-Resin is shown in FIGS. 6A-6F (PFOA-Resin mixed with 2 molar eq of sodium per mole fluorine in PFOA using NaOH, and FJH at 80 V for 1.00 s). FIG. 6A is XPS showing the high fluorine content in the original PFOA-Resin. FIG. 6B shows Fourier-transform infrared spectroscopy (FTIR) of the anion exchange resin with adsorbed PFOA. The C—F stretching vibration can be observed at 1204 and 1148 cm⁻¹. FIG. 6C is thermal gravimetric analysis-differential scanning calorimetry (TGA-DSC) showing the various stages of weight loss of the resin. (Plots 601-602 for weight and heat flow, respectively). The first stage includes PFOA degradation followed by depolymerization of the resin then blackening. FIG. 6D shows the reaction vessel after FJH. The sample shatters due to rapid gas formation and expansion. 80 V is the maximum voltage where the solid remains in the inner chamber and can be analyzed. FIG. 6E is an XRD analysis of the post reaction powder showing the presence of NaF. FIG. 6F shows ion chromatography results of the reactions. 66.7% of the PFOA is mineralized into inorganic NaF. The apparatus appeared to be a constraint of these samples as the glass tube shatters at high voltages. Using a polymer tube, a concrete brick, or placing the FJH apparatus into a pressure cell can help mitigate these effects.

### Molecular Dynamics Simulations

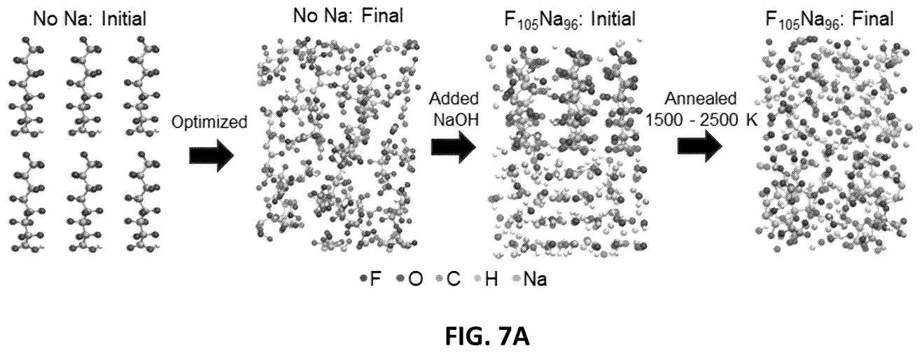

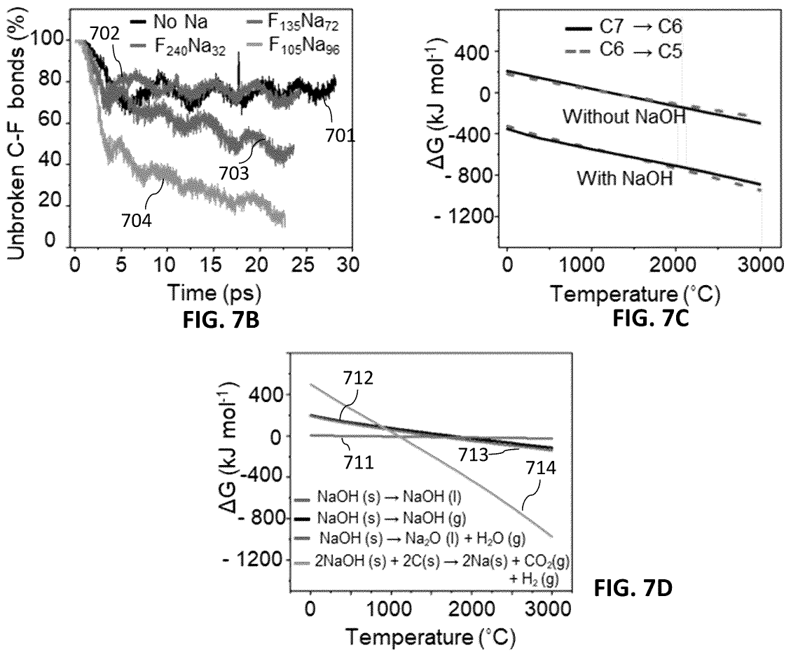

Optimized structures of PFOA and varying concentrations of NaOH were computationally heated at 1500 to 2500 K for 30 ps. FIG. 7A. Since the reaction leads to the cleavage of the C—F bonds in the PFAS, the number of C—F bonds in the system was used as a descriptor. FIG. 7B (with plots 701-704 for no Na, F₂₄₀Na₃₂, F₁₃₅Na₇₂, and F₁₀₅Na₉₆, respectively).

The results of these simulations interestingly revealed a catalytic role for the mineralization salts during an FJH reaction. In the absence of sodium salts, ~80% of the C—F bonds remained unbroken after annealing. For F to Na ratios of F₂₄₀Na₃₂, F₁₃₅Na₇₂, F₁₀₅Na₉₆ (in order of lowest to highest loading of Na), the amount of unbroken C—F bonds was 78%, 48%, and 15%, respectively. These reactions show that the ratio of unbroken bonds is substantially reduced with the addition of higher concentrations of sodium salts when annealed under similar conditions. Thus, sodium ions themselves promote the breakage of the C—F bond and enhance the rate of mineralization.

FIG. 7C shows the favorability of the reaction between fluorocarbons in the presence or absence of NaOH. The shaded gray region represents average reaction temperatures. FIG. 7D shows the change in the Gibbs free energy suggesting the most favorable reaction pathways for the NaOH mineralizing reagent during heating. (Plots 711-714 are (i) NaOH(s)→NaOH (1), (ii) NaOH(s)→NaOH(g), (iii) NaOH(s)→NaOH(l)+H₂O(g), and (iv) 2NaOH(s)+2C(s)→2Na(s)+CO₂(g)+H₂(g), respectively).

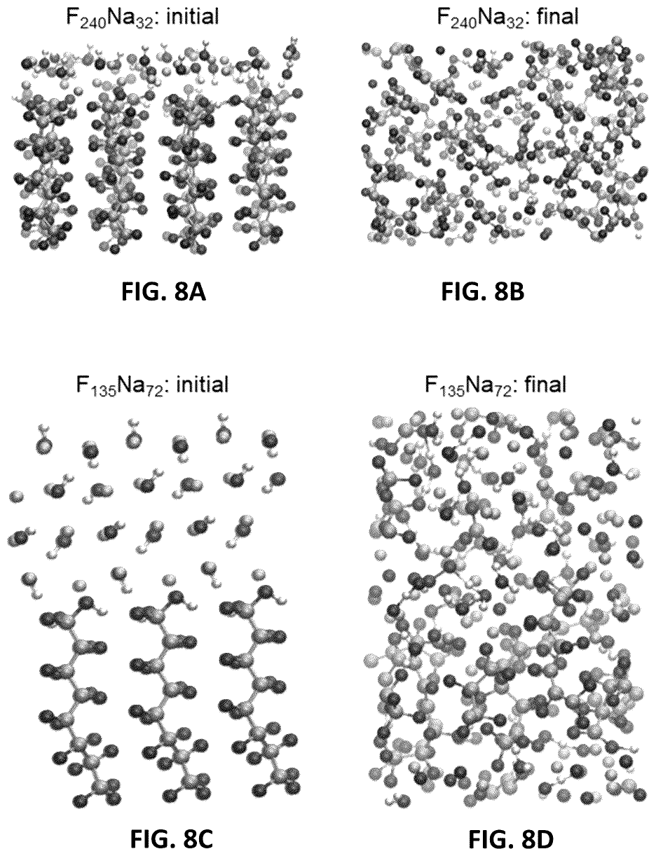

Similar catalytic properties likely exist for other alkali metals and alkaline earth metals. FIG. 8A-8D show the simulated and optimized structures for the lowest and intermediate loading of sodium salts. FIGS. 8A-8B show, respectively, molecular dynamics simulation of PFOA with the lowest loading of sodium salts (Na₃₂) before and after optimization. FIGS. 8C-8D show, respectively, Molecular dynamics simulation of PFOA with the median loading of sodium salts (Na₇₂) before and after optimization. The optimized structure is then annealed at temperatures ranging from 1500K to 2500K for 30 ps.

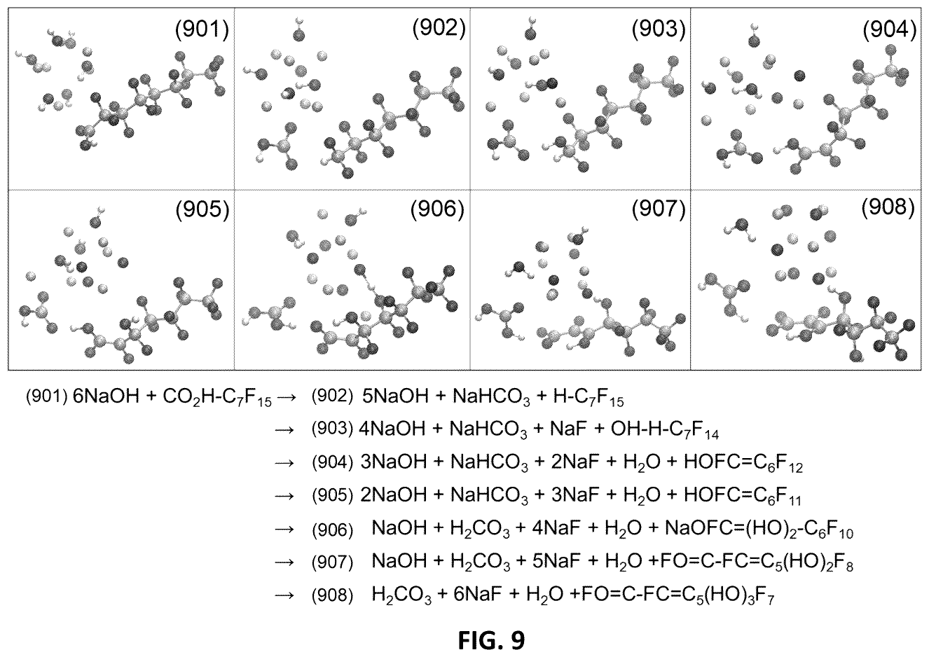

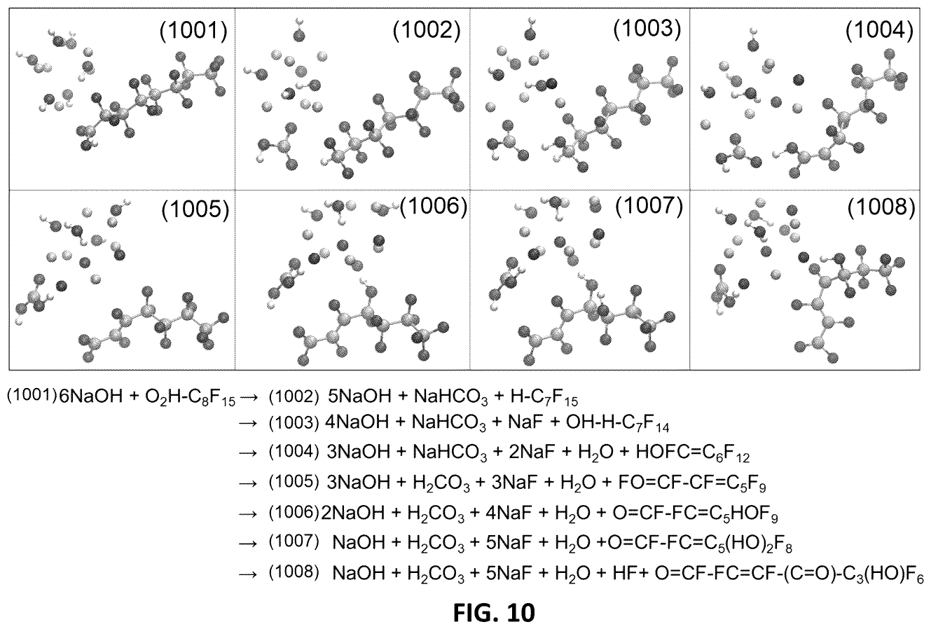

Molecular dynamic simulations were then conducted to investigate the reaction mechanisms and pathways. Based on MD simulation, the reaction of PFAS and NaOH produces several compounds, including oxidized carbon fragments with 5-, 6-, and 7-member rings, CO₃²⁻, NaF, H₂O, and other species. Guided by this, a mechanistic modeling of the reaction, 6 NaOH+O₂H—C8F₁₅, was performed by searching different pathways based on energetics analysis and DFT calculation. Three rules of thumb were used to guide the search: (1) Carbon atoms favor nonpolar covalent C—C or C═C bonding and polar covalent O—C or O═C bonding, (2) fluorine atoms favor ionic NaF or H—F bonding, and (3) the most energetically favorable reactions must keep the radicals (Na⁺, H⁺, F⁻, OH⁻, CO₃²⁻) balanced and the bonding network saturated (i.e., no dangling covalent bonds). The two searched reaction pathways are presented in FIGS. 9-10 with the corresponding atomic structures shown.

Insights on the mechanism for PFOA degradation via FJH can be obtained from these MD simulations and the observable reaction products. FIGS. 9-10 show the MD simulated intermediate steps for two distinct reaction pathways between NaOH and PFOA (Reaction Pathways 1 and 2, respectively). The first four steps (steps 901-904 of FIG. 9 and steps 1001-1004 of FIG. 10) in Reaction Pathways 1 and 2 are the same, signifying that the initiation of the reduction process is similar. However, the bonding environments of the intermediary species diverge from steps (steps 905-908 of FIG. 9 and steps 1005-1008 of FIG. 10) onwards. Energetic calculations were conducted for each step in the Reaction Pathways 1 and 2. Reaction Pathway 1 had lower energy for steps 905-908 (as compared to steps 1005-1008), likely due to a more favorable bonding environment in the intermediate species.

In both Reaction Pathways, the reaction was driven by the reduction of fluorine by sodium ions. Due to the high electronegativity of Fluorine atoms, the C—F covalent bonds are highly frustrated, and the replacement of F with OH or the removal of F through forming C═C double bonds is thermodynamically favorable. The activation energy required to displace F atoms and form more thermodynamically favorable products is likely lowered in the presence of sodium salts.

### Thermodynamic Analysis

Further theoretical analysis was conducted by calculating the change in the Gibbs free energy of the degradation steps after the decarboxylation of PFOA. In the absence of NaOH, shorter chain VOF can formed, such as C₇F₁₄, C₆F₁₂, and C₅F₁₀. It is known that PFOA tends to first decarboxylate upon heating, followed by subsequent reduction of its radical intermediary —C₇F₁₅. [Stoiber 2020]. The loss of a fluorine atom followed by rearrangement of the C—C bond to a C═C bond would produce C₇F₁₄, and the subsequent loss of —CF₂ and —C₂F₄ would produce C₆F₁₂ and C₅F₁₀, respectively. FIG. 7C shows that these reactions are highly exothermic in the presence of NaOH due to the formation of NaF. This principle extends to Ca(OH)₂, which forms the highly thermodynamically stable CaF₂ upon mineralization. FIGS. 5A-5F.

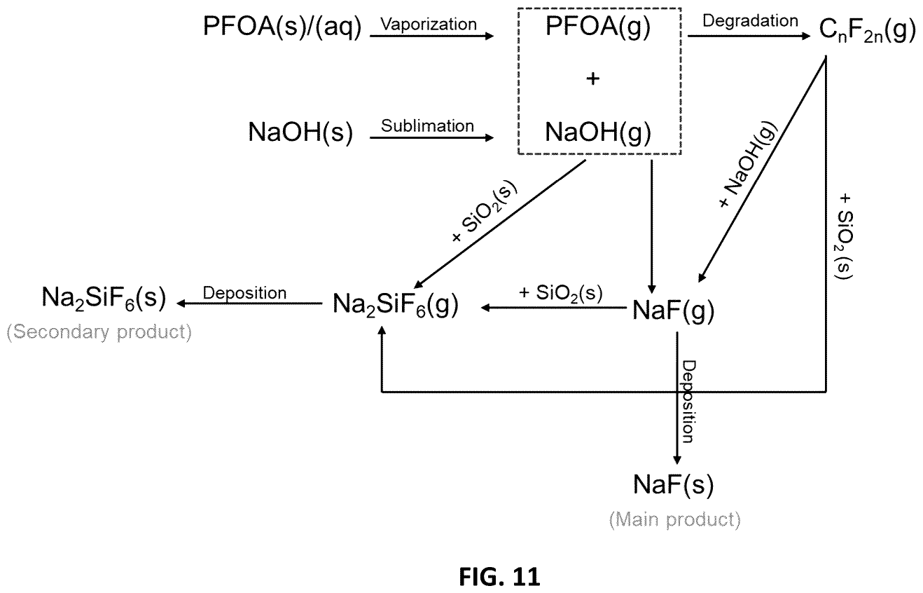

FIG. 7D shows the possible state of the NaOH during the reaction, and it was determined that there were Gibbs free energy changes of different reaction pathways involving NaOH, SiO₂, and perfluorocarbons (PFCs). In embodiments, >3000 °C can occur on the millisecond to seconds time scale. As a result, the FJH process experiences rapid heating and cooling rates. [Luong 2020; Chen 2022]. Given that the boiling points of most of the reactants are below this temperature, it is believed that the reactants vaporize or sublime, considering the reaction time scale. The gaseous products then mix to bring the mineralizing reagent into closer contact with the PFOA and react to form inorganic fluoride compounds that deposit and are further analyzed and quantified. FIG. 11 summarizes these believed species and their physical state. Plot 714 in FIG. 7D represents the carbothermal reduction of NaOH during FJH conditions, forming sodium metal (Na(0)) when T>1140 °C. This is an impetus for moving to use calcium salts such as Ca(OH)₂ or CaO when scaling up to minimize the accumulation of the more reactive Na(0).

### Life Cycle Assessment (LCA) and Techno-Economic Assessment (TEA)

Due to the prevalent use of GAC to remove PFAS from wastewater, copious amounts of this contaminated carbon are generated, so a variety of disposal pathways are currently being explored. To compare this FJH mineralization process to these other PFAS-GAC remediation methods, a comparative LCA was conducted. LCA is an analytical methodology used to examine the environmental impact of a product or process throughout its life cycle, from raw material extraction to disposal. [Finnveden 2009, Guinée 2011, Hellweg 2014].

Here, five different PFAS-GAC disposal scenarios were compared: direct incineration [Chang 2001], ball milling assisted mineralization [Zhang 2013], regeneration of GAC by microwave heating [Gaglano 2021], solvent extraction [Sirwardena 2021], and mineralization by FJH. For regeneration methods of GAC remediation, the GAC can be reused, typically up to four times [Sirwardena 2021]. Although NaOH was primarily used as the mineralizing reagent in FJH processes to facilitate the quantification of mineralized fluoride, it is posited that in a scaled-up process, a calcium-based mineralizing reagent would be used due to these reagents being more cost effective and without the generation of the more reactive sodium metal through carbothermic reduction during FJH. Furthermore, the inert and nontoxic byproduct, CaF₂, is more attractive since it is a natural mineralized form of fluoride in the environment, hence, the LCA and TEA were performed with Ca(OH)₂.

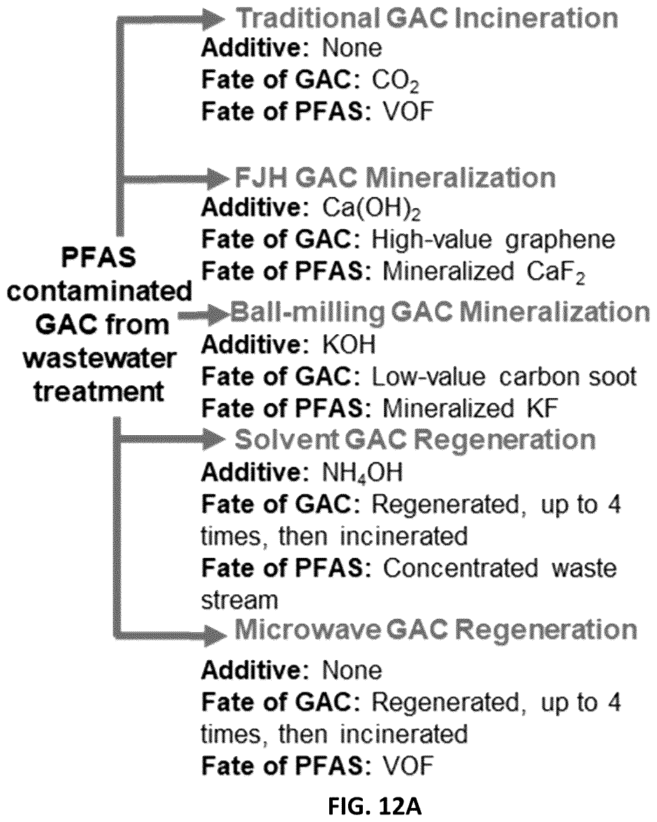

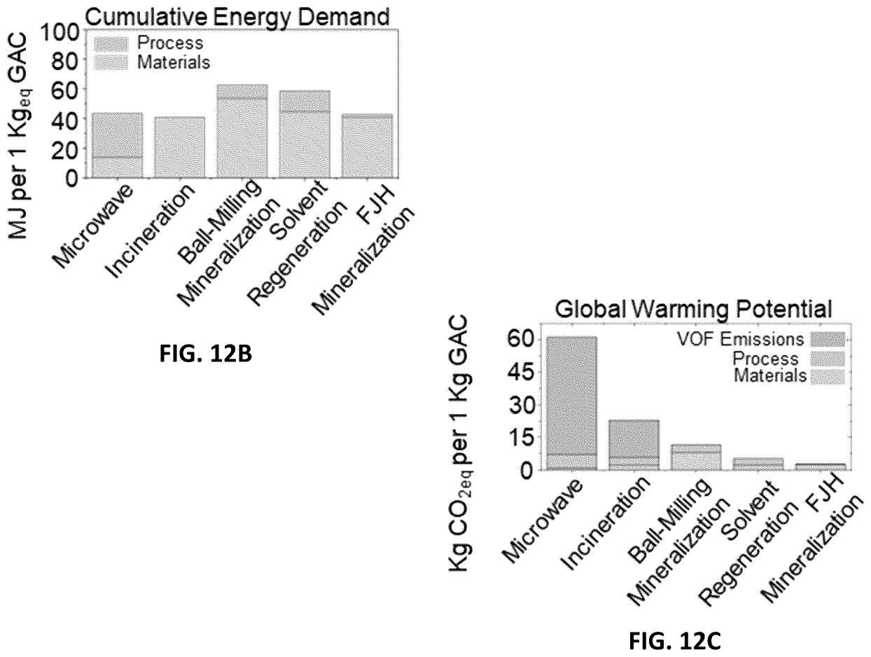

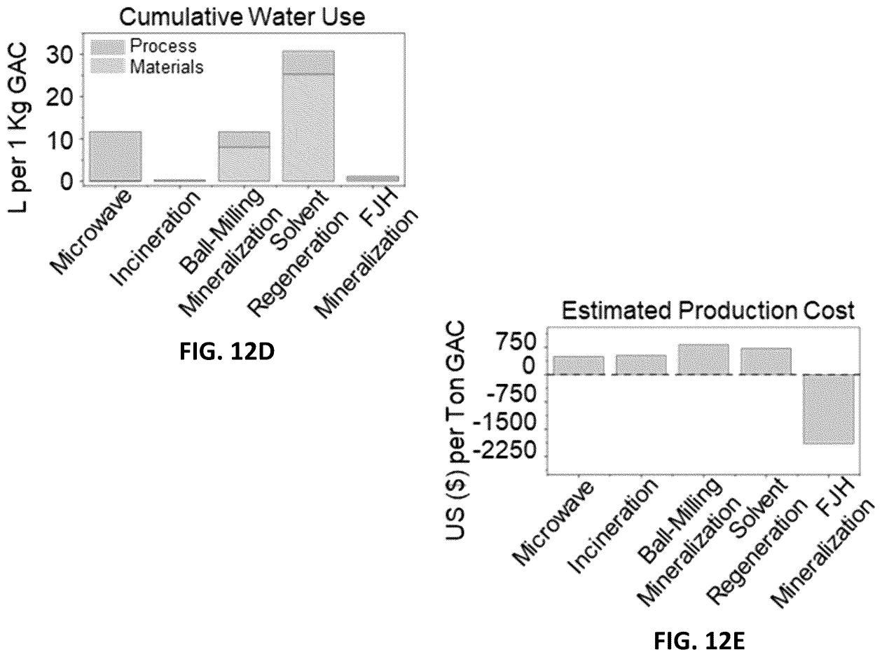

The fate of the GAC, PFAS, and any required additives for each method are shown in FIG. 12A. Incineration and microwave GAC regeneration can release the fluorine from the PFAS in the form of VOF or other partially degraded organofluorines. These compounds, in addition to potentially being highly toxic, have remarkably high global warming potential, up to 7,000 times worse than CO₂ due to long atmospheric lifetime and UV absorption.

FIG. 12B shows the cumulative energy demand for each process, demonstrating that compared to other methods, the FJH is highly efficient. FIG. 12C shows the global warming potential for each route. Due to the predicted production of VOF by microwave and incineration methods, since no mineralizing reagent is present, these methods have higher greenhouse gas emissions when compared to methods that mineralize fluoride. Incineration has the lowest cumulative water usage, followed closely by FJH (FIG. 12D). The production of the mineralizing reagent Ca(OH)₂ is responsible for the difference in water usage. Considering the typical PFAS content on GAC is ≤1 wt %, the amount of CaF₂ generated in the flash graphene product is minimal. In most cases, the non-toxic CaF₂ would not have to be removed, especially if the product flash graphene is slated for use in concrete and asphalt which is the largest potential market for this material.

High-frequency induction heating [Xiao 2023] and plasma heating [Singh 2019] are additional examples of thermal treatment methods and have recently been utilized in the treatment of PFAS-GAC at the laboratory scale. A brief comparison to FJH is demonstrated in Table VII.

TABLE VII
Comparison Of Various Thermal PFAS Degradation Technologies

| | PFAS removal | | |
|---|---|---|---|
| Process | efficiency | VOF | By-Products |
| FJH (Herein) | 99.98% in | In a fully seal system, | Graphene, NaF or CaF₂. GAC |
| | 1.00 s | we estimate that no | is upcycled to Graphene and |
| | | VOF is formed since | can be sold to offset the |
| | | using a partially sealed | material and production costs. |
| | | system resulted in a | ~96% organic F converted to |
| | | 99.81% reduction of | F⁻. NaF and CaF₂ are non- |
| | | fluoroalkene peaks | toxic inorganic salts that |
| | | determined by GC-MS. | provide a definite end-state |
| | | | for the released F⁻. |
| Induction | >90% in 45 s | VOF is present at | Inorganic fluoride ions F⁻ and |
| Heating | | temperatures ranging | HF. |
| [Xiao 2023] | | from 300-500 °C | The GAC may be regenerated |
| | | Most of the VOF | under optimal conditions. |
| | | vanish/ degrade around | |
| | | 890 °C. | |
| Plasma or | 90% of the | 1% to 2.5% of cyclic | Inorganic fluoride ions F⁻ and |
| Gasification | PFOA and | fluoroalkanes remain at | HF. Sorbed F to reactor walls |
| [Singh 2019] | PFOS | the end of the reaction | and tubing (either organic or |
| | reduction in 30 | (120 mins). | inorganic F). Organic F |
| | and 8 min, | | (remaining PFOA and PFOS). |
| | respectively, | | GAC could be regenerated |
| | using 0.66 | | and reused [Sahara 2024]. |
| | J/pulse. | | |
| Incineration | 99.99% in | VOF is present when the | Inorganic fluoride ions F⁻ and |
| | several | temperature is less than | HF [Watanabe 2016, |
| | minutes to a | 1000 °C [Watanabe | Dastgheib 2021]. |
| | few hours | 2016]. | GAC is converted to CO₂. |
| | [DiStefano | Insufficient heating | This process can produce |
| | 2022]. | duration may also | dioxins and furans [Hutzinger |
| | | contribute to VOF | 1985]. |
| | | formation. | |

The TEA results are shown in FIG. 12E, illustrating the materials and process costs associated with scaling up these remediation methods to the 1-tonne scale. The materials cost is derived from the starting GAC and reagents. The process cost is based on the electrical consumption used in each method. Notably, personnel and transportation costs were excluded from this analysis due to insufficient data in the literature. The starting material, GAC, can be transformed into valuable graphene, typically valued between $60,000 to $100,000 US per tonne [Wyss 2023]. Even considering a conservative worst-case scenario where graphene is sold at 5% of the low-end current cost, therefore sold at $3,000 US per tonne, this process demonstrates the potential for a significant profit of ~$1,900 US per tonne. The comparison of the five processes is before the cost of graphene is considered. Taken together, these assessments underscore the prospect of FJH for the mineralization of PFAS-laden sorbents. Translating findings from controlled environments to real-world scenarios can present challenges. Even at the lab scale, LCA and TEA have provided valuable insight into the environmental impacts and cost of processes and products.

### Applications

The FJH process can rapidly degrade PFAS compounds in the presence of mineralizing agents while producing little or no harmful shorter-chain PFAS, VOF, or hydrogen fluoride. Though demonstrated herein for PFOA, the most common type of PFAS found in water, it is understood that the FJH reaction temperatures of >3000 °C can likewise cause decomposition and mineralization of all PFAS types, when in the presence of sodium or calcium salts. Valuable graphene is produced as a product of this reaction, the sale of which can result in superior economic viability compared to other disposal methods that do not produce high value co-products. Instead of generating graphene, small modifications of the FJH process can alternatively afford carbon nanotubes, nanodiamonds, nanoshells, nanoonions, nanosheets, amorphous carbon, graphite, silicon carbide, silicon carbide whiskers and/or silicon carbide tubes, expanding the scope of the final carbon products [Wyss 2023, Cheng 2024, Chen 2021, Eddy 2024].

The methods of the present invention can be used to degrade PFAS compounds without producing/releasing harmful shorter chain PFAS, fluorocarbon, and hydrogen fluoride (HF). The byproduct, CaF₂, can serve as an inert, non-toxic form of inorganic fluoride. Additionally, it has a low solubility in water and most weak acids. Moreover, this byproduct does not need to be stored under dehydrated conditions, which could require more complex storage conditions. On the other hand, NaF is a readily available source of fluoride. It is highly soluble in water which makes fluoride quantification by ion chromatography easier. Overall, this process cleans up the environment by effectively destroying these toxic species. Joule heating is far more efficient than traditional heating methods, using less and or comparative energy and producing less greenhouse gases and secondary waste streams [Chen 2023].

It is further believed that one can leave the CaF₂ in the graphene and use that directly in concrete or asphalt [Min 2014; Nath 2015]. If one does not need to wash it with a mild acid to free it from the flash graphene, then that is a big saving. Its leaching into the environment would be slow due to its low solubility, and what does leach likely would not have a significant environmental impact since it is a natural mineral. Since there is very little free fluoride ion from CaF₂, destruction to the concrete rebar should be minimal.

The embodiments of the present invention provide methods that are faster, cheaper, easier, and more versatile than existing methods of PFAS degradation. Typical thermal methods heat samples for several minutes to hours. Embodiments of the present invention successfully mineralize PFAS in a matter of seconds. Likewise, it produces less waste (traces amounts of short chain PFAS could be re-flashed, as with any toxic fluorocarbon, and any HF would react with the calcium hydroxide or sodium hydroxide) in comparison to current techniques such as incinerating or thermal degradation of GAC/PFAS. The production of high-value graphene from hazardous materials can also economically incentivize the responsible disposal of PFAS using these methods.

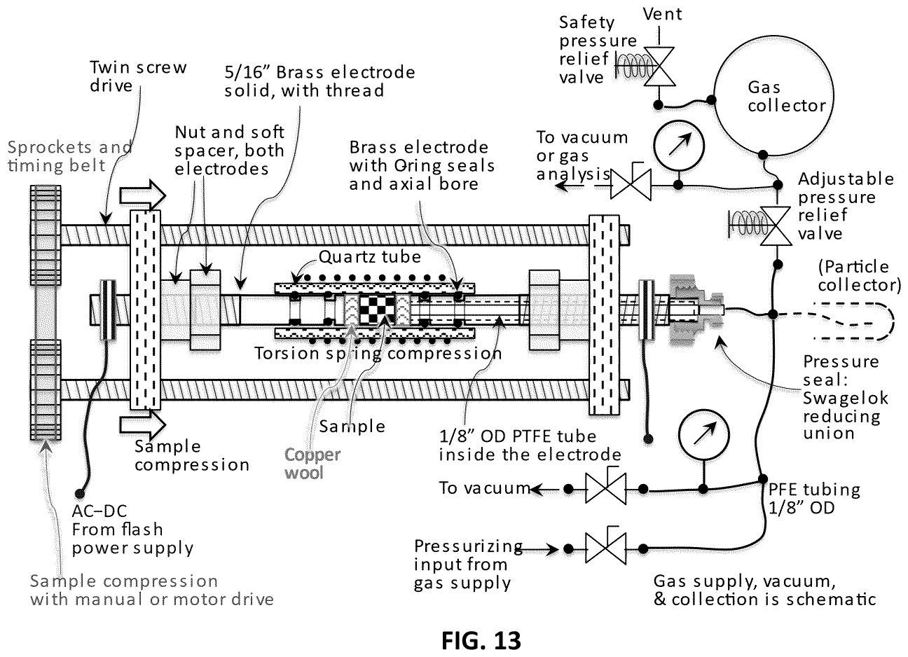

Furthermore, embodiments of the present invention can be utilized in a semi-automated FJH system with integrated off-gas venting, such as shown in the schematic in FIG. 13. Such flash process can take place in a closed and sealed pressure vessel. The container with the sample is inside the vessel, with electrodes connected, which is presently a quartz tube. The space external to the flash cell is pressurized with inert gas such as nitrogen or argon. The pressure helps keep the volatiles inside the flash cell, providing more time to react with the calcium or sodium compounds mixed in the GAC. After the flash, the gases are transferred to another vessel to be sure no volatiles remain in the product. Purging with inert gas or evacuation may be used. The gas mixture can be analyzed for any trace amounts of volatile perfluorocarbons, HF and/or F₂. Then the gases are passed through a second pressure vessel filled with GAC. This absorbs the perfluorocarbon fragments and HF, while the inert gas passes through and is released. As this process is scaled, containers other than quartz can be used, such as high-temperature-stable concrete or ceramics.

Notably, the volatiles are always confined, and all must pass through one (or more) GAC capture vessels, whereby the pressure can be optimized for efficient capture. Once the GAC has captured a sufficient number of volatiles then it is also treated in the primary flash pressure vessel to convert the remaining fluorocarbon fragments into metal salts. Whatever escapes from the first flash, will be trapped in the subsequent capture and flash. This will be a zero emissions or near-zero-emission device and process. Or one can have capture system for any escaped trace VOF and pass that through a combustion flame followed by HF scrubber.

The embodiments of the present invention can be varied by varying the voltage, sample resistance, capacitance, DC or AC or mixtures thereof, which is believed may have impact of the rate of fluoride mineralization.

While embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. The scope of protection is not limited by the description set out above, but is only limited by the claims which follow, that scope including all equivalents of the subject matter of the claims.

The disclosures of all patents, patent applications, and publications cited herein are hereby incorporated herein by reference in their entirety, to the extent that they provide exemplary, procedural, or other details supplementary to those set forth herein.

Amounts and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a” and “an” mean “one or more” when used in this application, including the claims.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that can vary depending upon the desired properties sought to be obtained by the presently disclosed subject matter.

As used herein, the term “about” and “substantially” when referring to a value or to an amount of mass, weight, time, volume, concentration or percentage is meant to encompass variations of in some embodiments ±20%, in some embodiments±10%, in some embodiments ±5%, in some embodiments±1%, in some embodiments ±0.5%, and in some embodiments ±0.1% from the specified amount, as such variations are appropriate to perform the disclosed method.

As used herein, the term “substantially perpendicular” and “substantially parallel” is meant to encompass variations of in some embodiments within ±10° of the perpendicular and parallel directions, respectively, in some embodiments within ±5° of the perpendicular and parallel directions, respectively, in some embodiments within ±1° of the perpendicular and parallel directions, respectively, and in some embodiments within ±0.5° of the perpendicular and parallel directions, respectively.

As used herein, the term “and/or” when used in the context of a listing of entities, refers to the entities being present singly or in combination. Thus, for example, the phrase “A, B, C, and/or D” includes A, B, C, and D individually, but also includes any and all combinations and sub-combinations of A, B, C, and D.

### REFERENCES

PCT Patent Appl. Serial Nos. PCT/US21/52030, PCT/US21/52043, PCT/US21/52057, and PCT/US21/52070, to James M. Tour et al., each entitled “Ultrafast Flash Joule Heating Synthesis Methods And Systems For Performing Same,” each filed Sep. 24, 2021 (collectively “Tour 2021 PCT Applications”).

PCT International Patent Appl. No. PCT/US/64987, entitled “Ultrafast Synthesis Of Holey And Wrinkled Graphene, to J. M. Tour, et al., filed Mar. 27, 2023 (“Tour PCT '987 Application”).
Al Amin, M., et al., “Recent Advances in the Analysis of Per- and Polyfluoroalkyl Substances (PFAS)—A Review,” Environ Technol Innov, 2020, 19, 100879 (“Al Amin 2020”).
Algozeeb, W. A., et al., “Flash Graphene from Plastic Waste,” ACS Nano, 2020, 14(11), 15595-15604 (“Algoeeb 2020”).
Aro, R., et al., “Organofluorine Mass Balance Analysis of Whole Blood Samples in Relation to Gender and Age,” Environ Sci Technol, 2021, 55(19), 13142-13151 (“Aro 2021”).
Beckham, J. L., et al., “Machine learning guided synthesis of flash graphene,” Adv. Mater, 2022, 34, 2106506 (“Beckham 2022”).
Belkouteb, N., et al., “Removal of per- and polyfluoroalkyl substances (PFASs) in a full-scale drinking water treatment plant: Long-term performance of granular activated carbon (GAC) and influence of flow-rate,” Water Res., 2020, 182, 115913 (“Belkouteb 2020”).
Blöchl, P. E., “Projector augmented-wave method,” Phys. Rev. B, 1994, 50, 17953-17979 (“Blöchl 1994”).
Brusseau, M. L., et al., “PFAS Concentrations in Soils: Background Levels versus Contaminated Sites,” Sci Total Environ, 2020, 740 (“Brusseau 2020”).
Buck, R. C., et al., “Perfluoroalkyl and Polyfluoroalkyl Substances in the Environment: Terminology, Classification, and Origins,” Integr Environ Assess Manag, 2011, 7(4), 513-541 (“Buck 2011”).
Chang, M. B., et al., “Characteristics of energy flow in municipal solid waste incinerator,” J. Environ. Eng., 2001, 127, 78-81 (“Chang 2001”).
Chen, W., et al., “Flash Recycling of Graphite Anodes. Advanced Materials, 2023, 35(8), 2207303 (“Chen 2023”).
Chen, W., et al., “Heteroatom-doped flash graphene,” ACS Nano, 2022, 16, 6646-6656 (“Chen 2022”).
Chen, W., et al., “Ultrafast and Controllable Phase Evolution by Flash Joule Heating,” ACS Nano 2021, 15, 11158-11167. (“Chen 2021”).
Cheng, Y., et al., “Flash upcycling of waste glass fibre-reinforced plastics to silicon carbide,” Nat. Sustainability, 2024, 7, 452-462 (“Cheng 2024”).
Cheng, Y., et al., “Electrothermal mineralization of per- and polyfluoroalkyl substances (PFAS) for soil remediation,” 2023, doi:10.26434/chemrxiv-2023-79t71. (“Cheng 2023”).
Chow, S. J., et al., “Comparative Investigation of PFAS Adsorption onto Activated Carbon and Anion Exchange Resins during Long-Term Operation of a Pilot Treatment Plant,” Water Res, 2022, 226, 119198 (“Chow 2022”).
Crosby, N. T., “Equilibria of fluorosilicate solutions with special reference to the fluoridation of public water supplies,” J Appl. Chem., 2007, 19, 100-102 (“Crosby 2007”).
Dastgheib, S. A., et al., “Thermogravimetric Studies for the Incineration of an Anion Exchange Resin Laden with Short- or Long-Chain PFAS Compounds Containing Carboxylic or Sulfonic Acid Functionalities in the Presence or Absence of Calcium Oxide,” Ind Eng Chem Res, 2021, 60(47), 16961-16968 (“Dastgheib 2021”).
Deng, B., et al., “High-temperature electrothermal remediation of multi-pollutants in soil,” Nat. Commun., 2023, 14, 6371 (“Deng 2023”).
DiStefano, R., et al. “Thermal destruction of PFAS during full-scale reactivation of PFAS-laden granular activated carbon, Rem. J, 2022, 32, 231-238 (“DiStefano 2022”).
Dong, S., et al., “Ultra-fast, low-cost, and green regeneration of graphite anode using flash joule heating method,” EcoMat, 2022, 4(5), e12212 (“Dong 2022”).
Duchesne, A. L., et al., “Remediation of PFAS-Contaminated Soil and Granular Activated Carbon by Smoldering Combustion,” Environ Sci Technol, 2020, 54(19), 12631-12640 (“Duchesne 2020”).
Dudarev, S. L., et al., “Electron-energy-loss spectra and the structural stability of nickel oxide: an LSDA+U study,” Phys. Rev. B, 1998, 57, 1505-1509 (“Dudarev 1998”).
Eddy, L., et al., “Electric Field Effects in Flash Joule Heating Synthesis,” J Am. Chem. Soc. 2024. DOI: 10.1021/jacs.4c02864. (“Eddy 2024”).
Ellis, D. A., et al., “The use of ¹⁹F NMR and Mass Spectrometry for the elucidation of novel fluorinated acids and atmospheric fluoroacid precursors evolved in the thermolysis of fluoropolymers,” Analyst, 2003, 128, 756 (“Ellis 2003”).
Ellis, D. A., et al., “Thermolysis of Fluoropolymers as a Potential Source of Halogenated Organic Acids in the Environment,” Nature, 2001, 412(6844), 321-324 (“Ellis 2001”).
Environmental Protection Agency, “Per- and Polyfluoroalkyl Substances (PFAS) Proposed PFAS National Primary Drinking Water Regulation” (2023) (“EPA 2023”).
Feng, M., et al., “Characterization of the thermolysis products of Nafion Membrane: A potential source of perfluorinated compounds in the environment,” Sci. Rep., 2015, 5, 9859 (“Feng 2015”).
Finnveden, G., et al., “Recent developments in life cycle assessment, J Environ. Manage., 2009, 91, 1-21 (“Finnveden 2009”).
Gagliano, E., et al., “Microwave regeneration of granular activated carbon saturated with PFAS,” Water Res., 2021, 198, 117121 (“Gagliano 2021”).
Gerken, M., et al., “The NMR shifts are not a measure for the nakedness of the fluoride anion,” J Fluorine Chem., 2002, 116, 49-58 (“Gerken 2002”).
Gluge, J., et al., “An overview of the uses of per- and polyfluoroalkyl substances (PFAS),” Environ. Sci.: Processes Impacts, 2020, 22, 2345-2373 (“Gluge 2020”).
Guinee, J. B., et al. “Life cycle assessment: Past, present, and future,” Environ. Sci. Technol., 2011, 45, 90-96 (“Guinee 2011”).
Hellweg, S., et al., “Emerging approaches, challenges and opportunities in life cycle assessment,” Science, 2014, 344, 1109-1113 (“Hellweg 2014”).
Hunter Anderson, R., et al., “Partitioning of Poly- and Perfluoroalkyl Substances from Soil to Groundwater within Aqueous Film-Forming Foam Source Zones,” J Contam Hydrol, 2019, 220, 59-65 (“Hunter Anderson 2019”).
Hutzinger, O., et al., “Formation of polychlorinated dibenzofurans and dioxins during combustion, electrical equipment fires and PCB incineration,” Environ. Health Perspect., 1985, 60, 3-9 (“Hutzinger 1985”).
Jia, X., et al., “Emerging and Legacy Per- and Polyfluoroalkyl Substances in an Elderly Population in Jinan, China: The Exposure Level, Short-Term Variation, and Intake Assessment,” Environ Sci Technol, 2022, 56(12), 7905-7916 (“Jia 2022”).
Kresse, G., et al., “Efficient iterative schemes for ab initio total-energy calculations using a plane-wave basis set,” Phys. Rev. B, 1996, 54, 11169-11186 (“Kresse 1996”).
Lee, M. C., et al., “Efficient Destruction of CF4 through in Situ Generation of Alkali Metals from Heated Alkali Halide Reducing Mixtures,” Environ Sci Technol, 2002, 36(6), 1367-1371 (“Lee 2002”).
Liao, M., et al., “Generating Energy and Greenhouse Gas Inventory Data of Activated Carbon Production Using Machine Learning and Kinetic Based Process Simulation,” ACS Sustainable Chem. Eng., 2020, 8, 1252-1261 (“Liao 2020”).
Liu, Y. L., et al., “Ion Exchange Removal and Resin Regeneration to Treat Per- and Polyfluoroalkyl Ether Acids and Other Emerging PFAS in Drinking Water,” Water Res, 2021, 207, 117781 (“Liu 2021”).
Loganathan, B. G., et al., “Perfluoroalkyl sulfonates and perfluorocarboxylates in two wastewater treatment facilities in Kentucky and Georgia,” Water Res., 2007, 41, 4611-4620 (“Loganathan 2007”).
Lu, J., et al., “Neural network based prediction of the efficacy of ball milling to separate cable waste materials,” Commun. Eng., 2023, 2, 1-9 (“Lu 2023”).
Luong, D. X., et al., “Gram-Scale Bottom-up Flash Graphene Synthesis,” Nature, 2020, 577, 647 (“Luong 2020”).
Martin, K. V., “PFAS soil concentrations surrounding a hazardous waste incinerator in East Liverpool, Ohio, an Environmental Justice Community.” Environ. Sci. Pollut. Res., 2023, 30, 80643-80654. (“Martin 2023”).
McCleaf, P., et al., “Removal Efficiency of Multiple Poly- and Perfluoroalkyl Substances (PFASs) in Drinking Water Using Granular Activated Carbon (GAC) and Anion Exchange (AE) Column Tests,” Water Res, 2017, 120, 77-87 (“McCleaf2017”).
Min, T. B., et al., “Experimental Study on the Development of Compressive Strength of Early Concrete Age Using Calcium-Based Hardening Accelerator and High Early Strength Cement,” Constr Build Mater, 2014, 64, 208-214 (“Min 2014”).
Monkhorst, H. J., et al., “Special points for Brillouin-zone integrations,” Phys. Rev. B, 1976, 13, 5188-5192 (“Monkhorst 1976”).
Nath, P., et al., “Use of OPC to Improve Setting and Early Strength Properties of Low Calcium Fly Ash Geopolymer Concrete Cured at Room Temperature,” Cem Concr Compos, 2015, 55, 205-214 (“Nath 2015”).
National Defense Authorization Act for fiscal year 2020 (“NDA 2019”).
Perdew, J. P., et al., “Generalized gradient approximation made simple,” Phys. Rev. Lett., 1996, 77, 3865-3868 (“Perdew 1996”).
Raymond, M. J., et al., “LCA approach to the analysis of solvent waste issues in the pharmaceutical industry,” Green Chem., 2010, 12, 1826-1834 (“Raymond 2010”).
Sahara, T., et al., “Investigation of Kinetic, Equilibrium, and Thermodynamic Modeling of Perfluorooctanoic Acid (PFOA) Adsorption in the Presence of Natural Organic Matter (NOM) by Dielectric Barrier Discharge Plasma-Modified Granular Activated Carbon (GAC),” Water, 2024, 16, 1499 (“Sahara 2024”).
Scher, D. P., et al., “Occurrence of Perfluoroalkyl Substances (PFAS) in Garden Produce at Homes with a History of PFAS-Contaminated Drinking Water,” Chemosphere, 2018, 196, 548-555 (“Scher 2018”).
Singh, R. K., et al., “Breakdown Products from Perfluorinated Alkyl Substances (PFAS) Degradation in a Plasma-Based Water Treatment Process” Environ. Sci. Technol., 2019, 53, 2731-2738 (“Singh 2019”).
Siriwardena, D. P., et al., “Regeneration of per- and polyfluoroalkyl substance-laden granular activated carbon using a solvent based technology,” J. Environ. Manage., 2021, 289, 112439 (“Siriwardena 2021”).
Sonmez Baghirzade, B., et al., “Thermal Regeneration of Spent Granular Activated Carbon Presents an Opportunity to Break the Forever PFAS Cycle,” Environ Sci Technol, 2021, 55(9), 5608-5619 (“Sonmez Baghirzade 2021”).
Stahl, T., et al., “Toxicology of perfluorinated compounds,” Environ. Sci. Eur., 2011, 23, 38 (“Stahl 2011”).
Stoiber, T., et al., “Disposal of Products and Materials Containing Per- and Polyfluoroalkyl Substances (PFAS): A Cyclical Problem,” Chemosphere, 2020, 260, 127659 (“Stoiber 2020”).
Sunderland, E. M., et al., “A review of the pathways of human exposure to poly- and perfluoroalkyl substances (PFASs) and present understanding of health effects,” J Exposure Sci. Environ. Epidemiol., 2018, 29, 131-147 (“Sunderland 2018”).
Suzuki, Y., et al., “Raman spectroscopy for determination of silicon oxyfluoride structure in fluoride melts,” J Fluorine Chem., 2020, 238, 109616 (“Suzuki 2020”).
Tsai, W.-T., “Environmental hazards and health risk of common liquid perfluoro-n-alkanes, potent greenhouse gases,” Environ. Int., 2009, 35, 418-424 (“Tsai 2009”).
Wang, B., et al., “Per- and polyfluoroalkyl substances and the contribution of unknown precursors and short-chain (C2-C3) perfluoroalkyl carboxylic acids at solid waste disposal facilities, Sci. Total Environ., 2020, 705, 135832 (“Wang 2020”).
Wang, F., et al., “Effectiveness and Mechanisms of Defluorination of Perfluorinated Alkyl Substances by Calcium Compounds during Waste Thermal Treatment,” Environ Sci Technol, 2015, 49(9), 5672-5680 (“Wang 2015”).
Wang, F., et al., “Influence of Calcium Hydroxide on the Fate of Perfluorooctanesulfonate under Thermal Conditions,” J Hazard Mater, 2011, 192(3), 1067-1071 (“Wang 2011”).
Wang, J., et al., “Critical Review of Thermal Decomposition of Per- and Polyfluoroalkyl Substances: Mechanisms and Implications for Thermal Treatment Processes,” Environ. Sci. Technol., 2022, 56, 5355-5370 (“Wang 2022”).
Watanabe, N., et al., “Thermal Mineralization Behavior of PFOA, PFHxA, and PFOS during Reactivation of Granular Activated Carbon (GAC) in Nitrogen Atmosphere,” Environmental Science and Pollution Research, 2018, 25(8), 7200-7205 (“Watanabe 2018”).
Watanabe, N., et al., “Residual Organic Fluorinated Compounds from Thermal Treatment of PFOA, PFHxA and PFOS Adsorbed onto Granular Activated Carbon (GAC),” Journal of Material Cycles and Waste Management, 2016, 18(4), 625-630 (“Watanabe 2016”).
Weber, N. H., et al., “Kinetics of Decomposition of PFOS Relevant to Thermal Desorption Remediation of Soils,” Ind Eng Chem Res, 2021, 60(25), 9080-9087 (“Weber 2021”).
Wyss, K. M., et al., “Upcycling and urban mining for nanomaterial synthesis,” Nano Today, 2023, 49, 101781 (“Wyss 2023”).
Xiao, F., et al., “Thermal phase transition and rapid degradation of forever chemicals (PFAS) in spent media using induction heating,” Environ. Sci. Technol., 2023, 3, 1370-1380 (“Xiao 2023”).
Xiao, F., et al., “Thermal Stability and Decomposition of Perfluoroalkyl Substances on Spent Granular Activated Carbon,” Environ Sci Technol Lett, 2020, 7(5), 343-350 (“Xiao 2020”).
Xiao, F., et al., “PFOA and PFOS Are Generated from Zwitterionic and Cationic Precursor Compounds during Water Disinfection with Chlorine or Ozone,” Environ Sci Technol Lett, 2018, 5(6), 382-388 (“Xiao 2018”).
Xiao, X., et al., “Sorption of Poly- and Perfluoroalkyl Substances (PFASs) Relevant to Aqueous Film-Forming Foam (AFFF)-Impacted Groundwater by Biochars and Activated Carbon,” Environ Sci Technol, 2017, 51(11), 6342-6351 (“Xiao 2017”).
Yakobson, B. I., et al., “Flash Graphene Morphologies,” ACS Nano, 2020, 14(10), 13691-13699 (“Yakobson 2020”).
Yeung, L. W. Y., et al., “Perfluorinated Compounds and Total and Extractable Organic Fluorine in Human Blood Samples from China,” Environ Sci Technol, 2008, 42(21), 8140-8145 (“Yeung 2008”).
Zhang, D., et al., “Sorption of Perfluoroalkylated Substances (PFASs) onto Granular Activated Carbon and Biochar,” Environ Technol., 2019, 42(12), 1798-1809 (“Zhang 2019”).
Zhang, K., et al., “Destruction of perfluorooctane sulfonate (PFOS) and perfluorooctanoic acid (PFOA) by ball milling,” Environ. Sci. Technol., 2013, 47, 6471-6477 (“Zhang 2013”).
Zhao, Y., et al., “Water-mediated cooperative migration of chemisorbed hydrogen on graphene,” Phys. Rev. Lett., 2014, 112(7), 076191 (“Zhao 2014”).

1. A method comprising:
(a) selecting a PFAS sorbed mixture comprising (i) a first substance selected from the group consisting of per- and polyfluorinated alkyl substances (PFAS) sorbed on (ii) a second substance selected from the group consisting of carbon, polymers, resins, and combinations thereof; and
(b) subjecting the PFAS sorbed mixture to a flash Joule heating process in the presence of a metal salt, metal oxide, or metal(O) to generate a carbon material and a metal fluoride.

2. The method of claim 1, wherein the generated carbon material is selected from the group consisting of carbon nanotubes, nanodiamonds, nanoshells, nanoonions, nanosheets, amorphous carbon, graphite, silicon carbide, silicon carbide whiskers, silicon carbide tubes, and combinations thereof.

3. (canceled)

4. The method of claim 1, wherein the the first substance comprises perfluorooctane carboxylate (PFOA) and/or perfluorooctane sulfonate (PFOS).

5. The method of claim 1, wherein the flash Joule process is performed utilizing the PFAS sorbed mixture and an added conductive additive.

6. The method of claim 1, wherein the PFAS sorbed mixture is subjected to the flash Joule heating process in the presence of the metal salt.

7. The method of claim 1, wherein the PFAS sorbed mixture is subjected to the flash Joule heating process in the presence of the metal oxide.

8. The method of claim 1, wherein the PFAS sorbed mixture is subjected to the flash Joule heating process in the presence of the metal(0).

9. The method of claim 1, wherein the metal salt, metal oxide, or metal(0) comprises a metal selected the group consisting of calcium, sodium, lithium, potassium and mixtures therefrom.

10. The method of claim 1, wherein the metal salt, metal oxide, or metal(0) comprises a metal that is aluminum.

11. The method of claim 1, wherein the metal salt, metal oxide, or metal(0) comprises a metal i-s selected from the group consisting of Group 1A, Group 2A, Group 3A, and transition metals, and mixtures thereof.

12. The method of claim 1, wherein the the second substance is granulated activated charcoal (GAC).

13. The method of claim 12 further comprising the step of forming the PFAS sorbed mixture by sorbing the PFAS on the GAC.

14. The method of claim 1, wherein the flash Joule heating process is performed utilizing the the first substance physically mixed with granulated activated charcoal (GAC) and the metal salt, metal oxide, or metal(0).

15. The method of claim 14, wherein the the first substance is a non-soluble PFAS.

16. The method of claim 1, wherein the the second substance is a resin. Duplicated Numbered claims 13-16. (canceled)

17. The method of claim 1, wherein the metal fluoride is Na₂SiF₆.

18. The method of claim 1, wherein at least 90% of fluorine atoms in the PFAS of the PFAS sorbed mixture is converted into the metal fluoride.

19-20. (canceled)

21. The method of claim 1, wherein the method comprises a zero emissions or near-zero-emissions process.

22. The method of claim 1, wherein the metal fluoride is inorganic, inert, and non-toxic.

23. The method of claim 1 further comprising removing the metal fluoride from the carbon material by washing with water or an aqueous acid.

24. A composite material comprising carbon nanotubes and/or silicon carbide nanowhiskers formed by the method of claim 1.

25. (canceled)

26. The composite material of claim 24, wherein the composite material further comprises a composite selected from the group consisting of cement, concrete, asphalt, plastic, wood, paint, coatings, films, inhibitors, rust inhibitors, and lubricants.

27. The method of claim 16, wherein the resin is a carbon-silicon-containing resin.

28. The method of claim 16, wherein the resin is an anion exchange resin (AER).

29. The method of claim 1, wherein the metal fluoride is CaF₂ and/or NaF.

30. The method of claim 1, wherein the metal fluoride is AlF₃.
